(19) United States
(12) Patent Application Publication
(10) Pub. No.: US 2026/0080067 A1
(43) Pub. Date: Mar. 19, 2026

(54) SYSTEMS AND METHODS FOR ARTIFICIAL INTELLIGENCE (AI)-DRIVEN CYBERSECURITY ENCLAVES

(71) Applicant: The Travelers Indemnity Company, Hartford, CT (US)

(72) Inventors: William A. O'Hern, Spring Lake, NJ (US); Joshua P. Bugryn, Torrington, CT (US); Lawrence A. Senechal, Ellington, CT (US); Michael C. Kunkel, Glastonbury, CT (US); Sereres C. Riordan, Riverside, IL (US)

(21) Appl. No.: 18/882,419

(22) Filed: Sep. 11, 2024

Related U.S. Application Data
(63) Continuation of application No. 18/388,615, filed on Nov. 10, 2023, now Pat. No. 12,124,592.

(51) Int. Cl. G06F 21/57; G06N 20/00

(52) U.S. Cl. CPC G06F 21/577; G06N 20/00; G06F 2221/034

(57) ABSTRACT

Systems, apparatus, methods, and articles of manufacture for AI-driven cybersecurity enclaves, such as a computerized environment that executes one or more specially-trained AI models to govern communications between users and AI service providers.

### CROSS-REFERENCE TO RELATED APPLICATIONS

Benefit and priority under 35 U.S.C. § 120 is hereby claimed to, and this is a Continuation of, U.S. patent application Ser. No. 18/388,615 filed on Nov. 10, 2023 and titled “SYSTEMS AND METHODS FOR ARTIFICIAL INTELLIGENCE (AI)-DRIVEN CYBERSECURITY ENCLAVES”, which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND

Generative Artificial Intelligence (GenAI) services have quickly become mainstream and are used by individuals to automatically generate various media for a wide variety of purposes. Services such as ChatGPT (Chat Generative Pre-trained Transformer) provided by OpenAI, Inc./OpenAI Global, LLC of San Francisco, CA, and PaLM (Pathways Language Model) provided by Google AI/Google LLC/Alphabet Inc. of Mountain View, CA, are now available via general (free) and paid service offerings and have been increasingly used by enterprise end users to automate task completion, such as the automated generation of context-specific emails and other media. As these AI models are typically trained utilizing user inputs, however, enterprise users risk exposing company trade secrets, confidential information, and other intellectual property by utilization of the AI services. Many organizations have accordingly implemented policies limiting (or outright preventing) the use of GenAI services by employees.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1 is a block diagram of a system according to some embodiments;

FIG. 2 is a block diagram of a system according to some embodiments;

FIG. 3 is a block diagram of a system according to some embodiments;

FIG. 4 is a system flow diagram of a method according to some embodiments;

FIG. 5 is a flow diagram of a method according to some embodiments;

FIG. 6 is a block diagram of an example watermarking process according to some embodiments;

FIG. 7A, FIG. 7B, FIG. 7C, and FIG. 7D are diagrams of an example interface system according to some embodiments;

FIG. 8A and FIG. 8B are diagrams of an example interface system according to some embodiments;

FIG. 9A, FIG. 9B, and FIG. 9C are diagrams of an example interface system according to some embodiments;

FIG. 10 is a block diagram of an apparatus according to some embodiments;

FIG. 11A, FIG. 11B, FIG. 11C, FIG. 11D, and FIG. 11E are perspective diagrams of exemplary data storage devices according to some embodiments; and

FIG. 12 is a flow diagram of an algorithm according to some embodiments.

### DETAILED DESCRIPTION

### I. Introduction

Traditional cybersecurity protocols and services are generally capable of implementing a discrete set of policies or rules, for example, to identify and prevent occurrences of an employee transmitting Personally Identifiable Information (PII), such as a Social Security Number (SSN) or credit card numbers outside of a company system (e.g., Data Loss Prevention (DLP). Such systems are not capable, however, of monitoring and managing employee interactions with AI services, which is why many companies have prohibited AI service use by employees. Traditional systems cannot, for example, reduce the risk of confidential information (e.g., that is not a specific type of PII for which the system is programmed to recognize) and/or intellectual property data from being consumed and/or made public by an external AI service.

In accordance with embodiments herein, these and other deficiencies of existing systems are remedied by providing systems, apparatus, methods, and articles of manufacture for AI-driven cybersecurity enclaves. In some embodiments, for example, a specially-trained AI cybersecurity model may be implemented to function as an enclave from which AI service requests are managed. According to some embodiments, the AI model may be trained to provide (i) standardized data logging services, (ii) data fingerprinting and/or watermarking services, (iii) content moderation services, and/or (iv) risk-based access control services, all as described herein. In such a manner, for example, the AI cybersecurity enclave may function as an AI gatekeeper for AI service requests, reducing AI service usage/exposure risks, while enabling employees/users to realize the benefits of utilizing AI services.

### II. AI-Driven Cybersecurity Enclave Systems

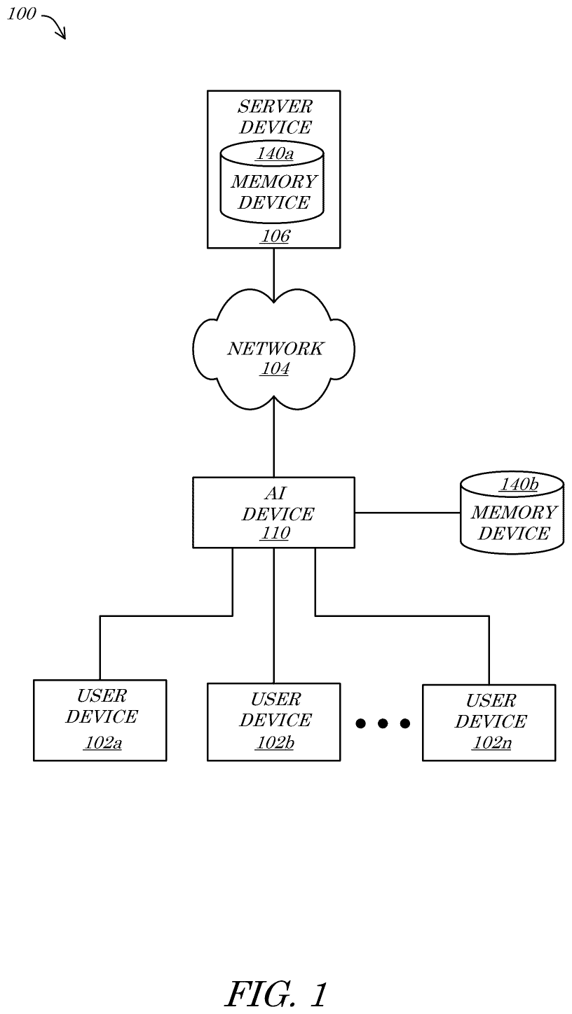

Referring first to FIG. 1, a block diagram of a system 100 according to some embodiments is shown. In some embodiments, the system 100 may comprise a plurality of user devices 102a-n, a network 104, a third-party or server device 106, and/or an AI device 110. According to some embodiments, any or all of the components 102a-n, 106, 110 may comprise and/or be in communication with data storage and/or memory devices 140a-b. The server device 106 may comprise a first memory device 140a, for example, and/or the server device 106, the AI device 110, and/or the user devices 102a-n may comprise and/or have access to a second memory device 140b. As depicted in FIG. 1, any or all of the components 102a-n, 106, 110, 140a-b (or any combinations thereof) may be in communication via the network 104. In some embodiments, communications between and/or within the components 102a-n, 106, 110, 140a-b of the system 100 may be utilized to provide an AI-driven cybersecurity enclave management platform. The server device 106 may, for example, interface with one or more of the user devices 102a-n and/or the AI device 110 to execute a pre-trained AI model (not depicted) stored in the second memory device 140b and/or provide a specially-structured interface via which a user (not separately shown; e.g., of a user device 102a-n) may access and/or utilize an AI service provided by the server device 106. The AI service (not depicted) may be stored in the first memory device 140a, for example, and may be passed, input filtered, structured, encoded, forwarded, and/or otherwise provided by the AI device 110, e.g., in response to a request from a user device 102a-n to utilize, invoke, and/or execute the AI service.

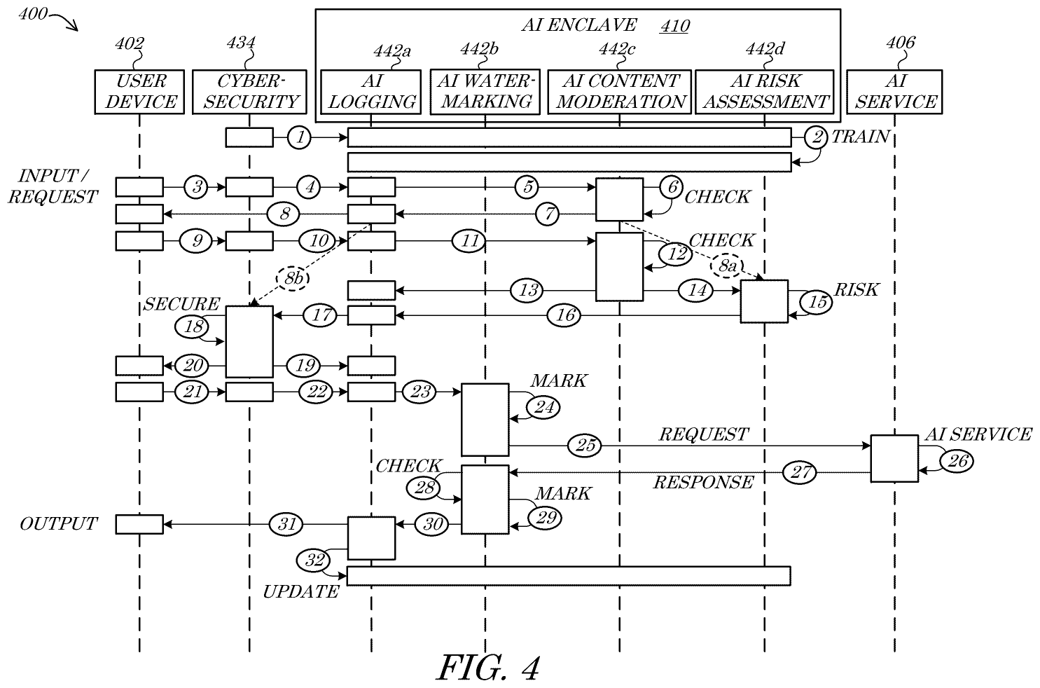

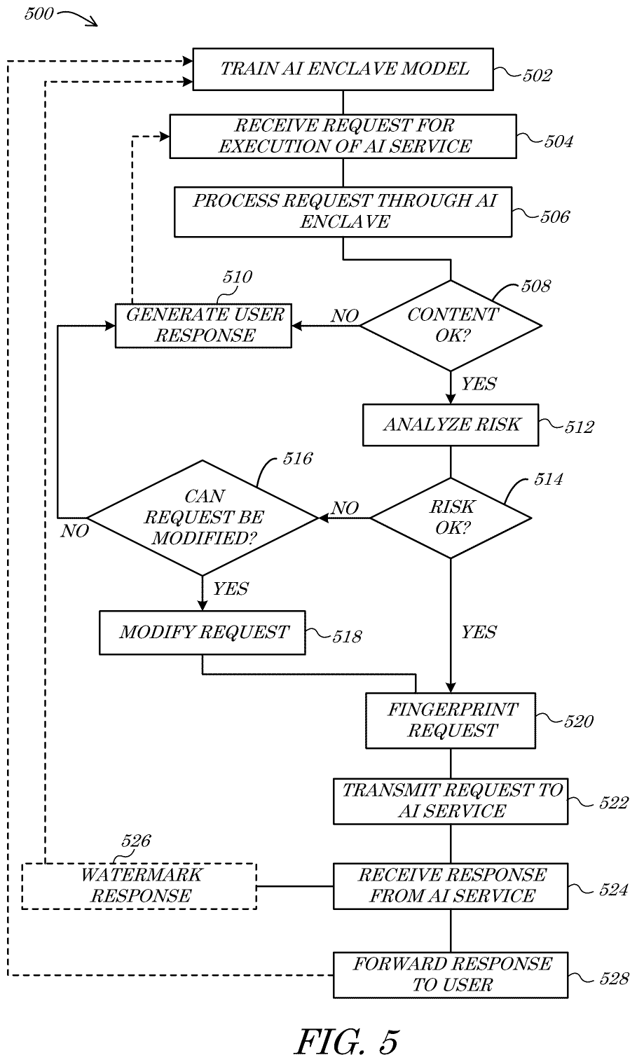

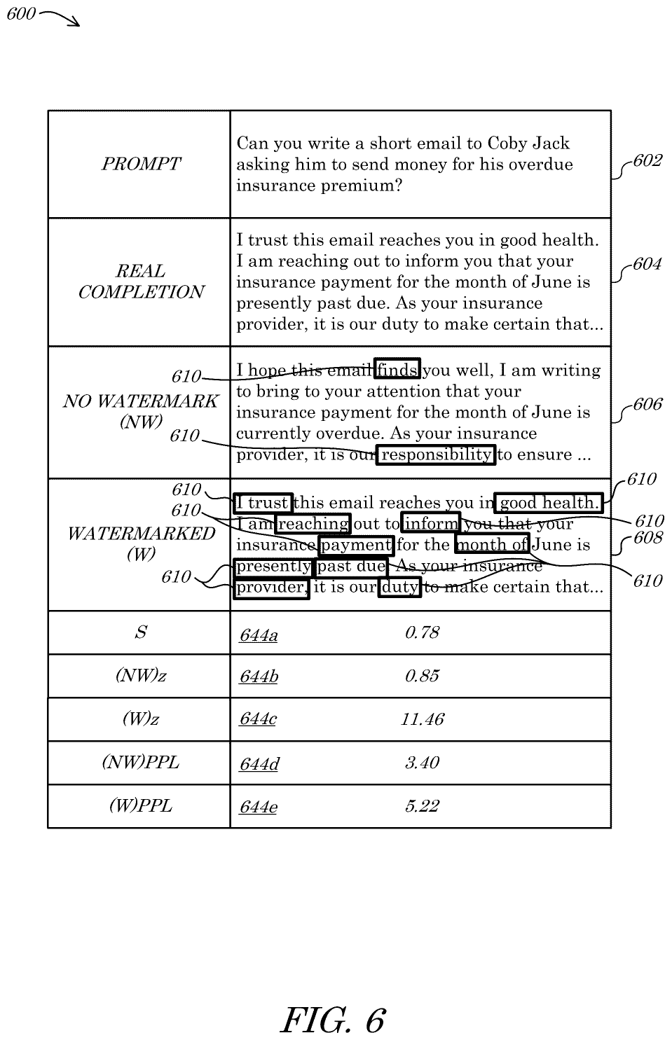

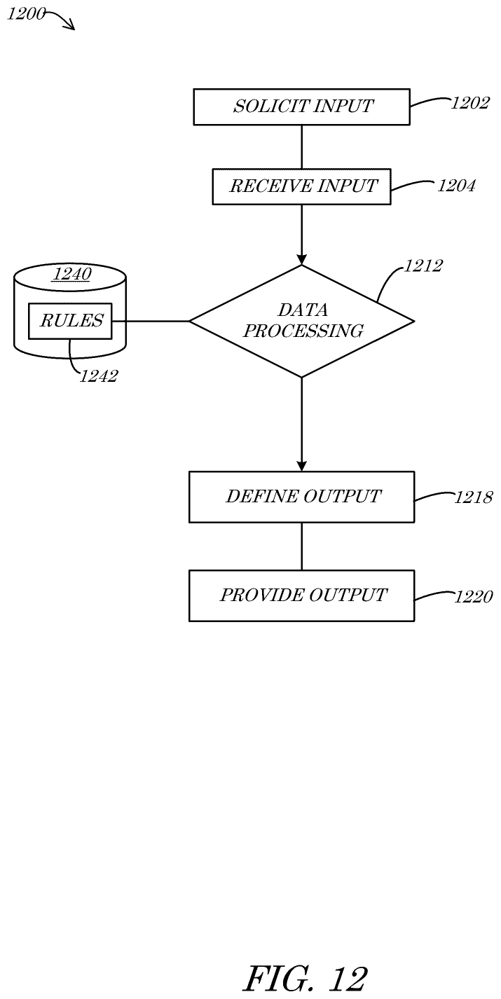

Fewer or more components 102a-n, 104, 106, 110, 140a-b and/or various configurations of the depicted components 102a-n, 104, 106, 110, 140a-b may be included in the system 100 without deviating from the scope of embodiments described herein. In some embodiments, the components 102a-n, 104, 106, 110, 140a-b may be similar in configuration and/or functionality to similarly named and/or numbered components as described herein. In some embodiments, the system 100 (and/or portions thereof) may comprise an AI-driven cybersecurity enclave management program, system, and/or platform programmed and/or otherwise configured to execute, conduct, and/or facilitate the methods/algorithms 400, 500, 600, 1200 of FIG. 4, FIG. 5, FIG. 6, and/or FIG. 12 herein, and/or portions or combinations thereof.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., an enterprise employee workstation), tablet computers, such as an iPad® manufactured by Apple®, Inc. of Cupertino, CA, and/or cellular and/or wireless telephones, such as an iPhone® (also manufactured by Apple®, Inc.) or an LG Optimus™ Zone™ 3 smart phone manufactured by LG® Electronics, Inc. of San Diego, CA, and running the Android® operating system from Google®, Inc. of Mountain View, CA. In some embodiments, the user devices 102a-n may comprise devices owned and/or operated by one or more users, such as cyber insurance agents, underwriters, account managers, brokers, customer service representatives, employees, and/or consultants or service providers. According to some embodiments, the user devices 102a-n may communicate with the AI device 110 directly (as depicted) and/or via the network 104 to provide requests to utilize one or more AI services provided by the server device 106, e.g., in accordance with AI-driven cybersecurity enclave management protocols and/or processes as described herein. According to some embodiments, any of the user devices 102a-n may communicate with the server device 106 through and/or via the AI device 110. The AI device 110 may, for example, execute a trained AI model stored in the second memory device 140b to manage communications (e.g., communication sessions, data transmissions, and/or data inputs and/or data outputs) between one or more of the user devices 102a-n and the server device 106 (e.g., which may provide an AI service in accordance with an AI model stored in the first memory device 140a). In some embodiments, the user devices 102a-n may interface with the AI device 110 to effectuate communications (direct or indirect) with one or more other user devices 102a-n (such communication not explicitly shown in FIG. 1) operated by other users.

The network 104 may, according to some embodiments, comprise a Local Area Network (LAN; wireless and/or wired), cellular telephone, Bluetooth®, Near Field Communication (NFC), and/or Radio Frequency (RF) network with communication links between the AI device 110, the user devices 102a-n, the server device 106, and/or the memory devices 140a-b. In some embodiments, the network 104 may comprise direct communications links between any or all of the components 102a-n, 106, 110, 140a-b of the system 100. The user devices 102a-n may, for example, be directly interfaced or connected to one or more of the AI device 110 and/or the second memory device 140b via one or more wires, cables, wireless links, and/or other network components, such network components (e.g., communication links) comprising portions of the network 104. In some embodiments, the network 104 may comprise one or many other links or network components other than those depicted in FIG. 1. The AI device 110 may, for example, be connected to the server device 106 and/or the user devices 102a-n via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110, 140a-b of the system 100. The network 104 may comprise one or more cellular telephone networks with communication links between the user devices 102a-n and the AI device 110, for example, and/or may comprise the Internet, with communication links between the AI device 110 and the server device 106 and/or one or more of the memory devices 140a-b, for example.

The server device 106, in some embodiments, may comprise any type or configuration of a computerized processing device, such as a PC, laptop computer, computer server, database system, and/or other electronic device, devices, or any combination thereof. In some embodiments, the server device 106 may be owned and/or operated by a third-party (i.e., an entity different than any entity owning and/or operating either the user devices 102a-n or the AI device 110; such as an AI service provider). The server device 106 may, for example, execute one or more AI-based web services that provide GenAI data processing. According to some embodiments, the server device 106 may comprise a plurality of devices and/or may be associated with a plurality of third-party entities and/or AI services.

In some embodiments, the AI device 110 may comprise an electronic and/or computerized controller device, such as a computer server communicatively coupled to interface with the user devices 102a-n and/or the server device 106 (directly and/or indirectly). The AI device 110 may, for example, comprise one or more PowerEdge™ R830 rack servers manufactured by Dell®, Inc. of Round Rock, TX, which may include one or more Twelve-Core Intel® Xeon® E5-4640 v4 electronic processing devices. In some embodiments, the AI device 110 may comprise a plurality of processing devices specially-programmed to execute and/or conduct processes that are not practicable without the aid of the AI device 110. The AI device 110 may, for example, train and/or execute one or more AI models (e.g., stored in the second memory device 140b) that manage and/or facilitate communications between the user devices 102a-n and the server device 106 in a manner that provides enhanced security and reduces the risk of utilizing the AI service(s) provided by the server device 106, which would not be capable of being conducted without the benefit of the specially-programmed AI device 110. According to some embodiments, the AI device 110 may be located remotely from one or more of the user devices 102a-n and/or the server device 106. The AI device 110 may also or alternatively comprise a plurality of electronic processing devices located at one or more various sites and/or locations (e.g., distributed and/or virtual computing).

According to some embodiments, the AI device 110 may store and/or execute specially programmed instructions to operate in accordance with embodiments described herein. The AI device 110 may, for example, execute one or more models (e.g., AI models), algorithms, programs, modules, and/or routines that facilitate a risk-reduced utilization of the AI service(s) provided by the server device 106, to one or more of the user devices 102a-n. According to some embodiments, the AI device 110 may comprise a computerized processing device, such as a computer server and/or other electronic device, to manage and/or facilitate transactions, transmissions, and/or communications regarding the user devices 102a-n. An enterprise user, corporate employee, agent, claim handler, underwriter, and/or other user may, for example, utilize the AI device 110 to (i) send an AI service request (e.g., AI prompts) to the server device 106, (ii) have the AI service request automatically edited to reduce risk of utilizing the AI service, (iii) have the AI service request tagged or fingerprinted, (iv) have the AI service request automatically routed to one of a plurality of server devices 106, (v) have an expected cost of the AI service request computed, (vi) receive an AI service response from the server device 106, (vii) perform watermarking on the AI service response, and/or (viii) have the AI service request and/or response dynamically risk-assessed, as described herein.

In some embodiments, the user devices 102a-n, the server device 106, and/or the AI device 110 may be in communication with the memory devices 140a-b. The memory devices 140a-b may comprise, for example, various databases and/or data storage mediums that may store, for example, data descriptive of the user devices 102a-n, user preference and/or characteristics data, historic user, user device 102a-n, AI service request, and/or AI service response data, geolocation data, historic cybersecurity metrics (e.g., statistics), AI models, chain code instructions, blockchain data, cryptographic keys and/or data, login and/or identity credentials, and/or instructions that cause various devices (e.g., the AI device 110, the server device 106, and/or the user devices 102a-n) to operate in accordance with embodiments described herein.

The memory devices 140a-b may store, for example, AI-based cybersecurity enclave instructions and/or models, chain code instructions, and/or data that causes managed communications between the server device 106 and the user devices 102a-n (e.g., an API and/or API tunnel to a web service that provides AI-based risk assessment, content moderation, logging, monitoring, blockchain authentication, certification, and/or cryptographic hashing). In some embodiments, the memory devices 140a-b may comprise any type, configuration, and/or quantity of data storage devices that are or become known or practicable. The memory devices 140a-b may, for example, comprise an array of optical and/or solid-state hard drives configured to store AI services data provided by (and/or requested by) the user devices 102a-n, cybersecurity risk assessment analysis data (e.g., historical data, analysis formulas, and/or mathematical models), and/or various operating instructions, drivers, etc. While the second memory device 140b is depicted as a stand-alone component disembodied from (but in communication with) the various user devices 102a-n and the AI device 110, the second memory device 140b may comprise multiple components and/or may be part of any or all of the user devices 102a-n and the AI device 110. In some embodiments, multi-component memory devices 140a-b may be distributed across various devices and/or may comprise remotely dispersed components. Any or all of the user devices 102a-n, the server device 106, and/or the AI device 110 may comprise the memory devices 140a-b or a portion thereof, for example.

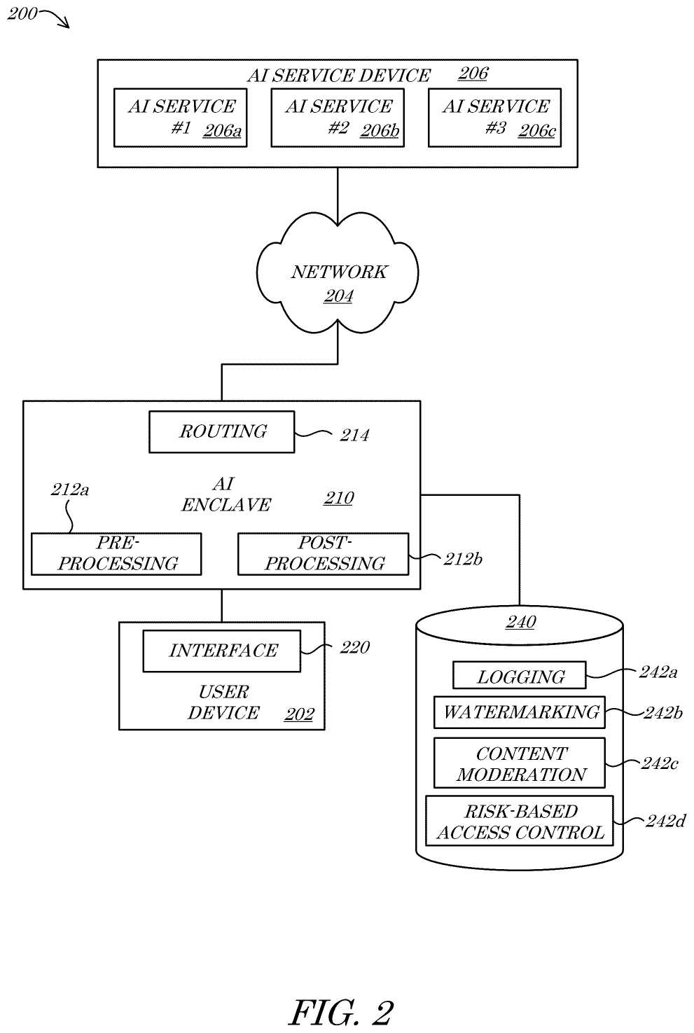

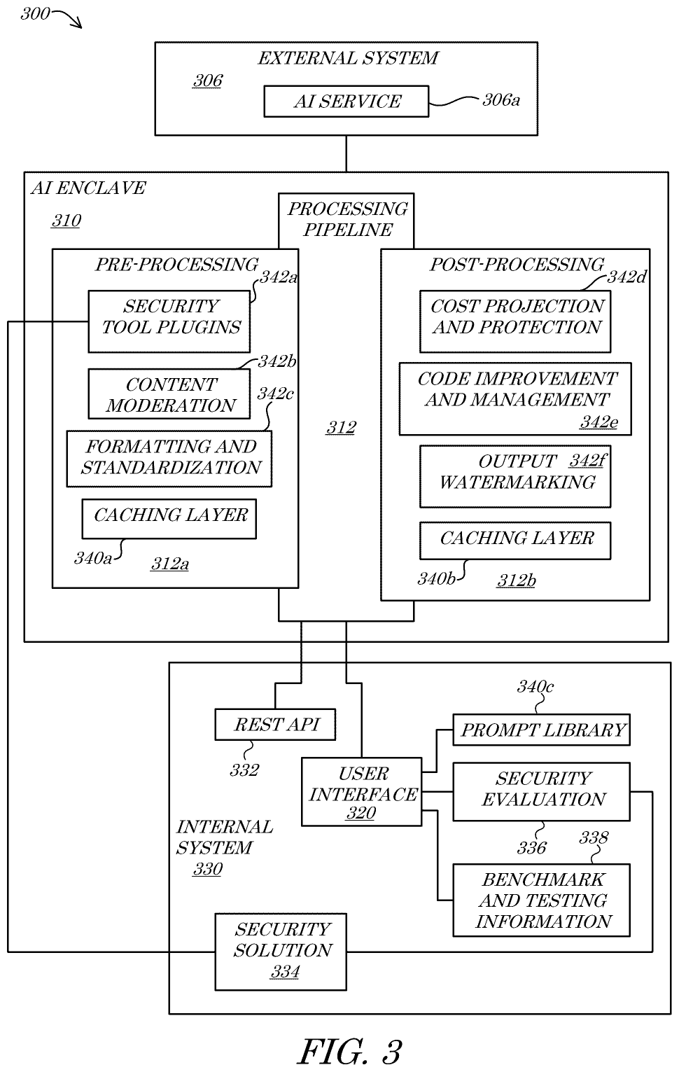

Turning now to FIG. 2, a block diagram of a system 200 according to some embodiments is shown. In some embodiments, the system 200 may comprise a user device 202 that may be utilized, for example, to provide AI service requests (not separately shown) via a network 204 to an AI service device 206 (e.g., that provides and/or executes a first AI service 206a, a second AI service 206b, and/or a third AI service 206c). According to some embodiments, the system 200 may comprise an AI enclave 210 through which communications between the user device 202 and the AI service device 206 are routed, filtered, processed, and/or managed. In some embodiments, the AI enclave 210 may comprise, define, and/or implement, for example, pre-processing 212a and/or post-processing 212b of input and/or output data related to communications to and/or from the user device 202. According to some embodiments, the AI enclave 210 may comprise, define, and/or implement, data routing 214. The AI enclave 210 may, for example, dynamically and/or automatically route, redirect, analyze, compress/decompress, encode/decode, and/or load balance transmissions between the user device 202 and the AI service device 206 (and/or one or more of the AI services 206a-c) and/or one or more other devices (not shown). In some embodiments, the AI enclave 210 may generate, comprise, and/or conduct communications with the user device 202 through an interface 220. The interface 220 may, for example, comprise a Graphical User Interface (GUI) generated and/or executed on the user device (and/or the AI enclave 210) that enables a user (not shown) of the user device 202 to define and/or submit AI requests (e.g., prompts and/or queries) for one or more of the AI services 206a-c, and/or via which responses to such requests are received and/or output. According to some embodiments, the user device 202 and/or the AI enclave 210 may also or alternatively be in communication with and/or comprise a memory device 240 (e.g., which may be implemented and/or defined by an object data store and/or other data storage technique and/or service, such as utilizing the Amazon® Simple Storage Service (Amazon® S3™) available from Amazon. com, Inc. of Seattle, WA or an open-source third-party database service, such as MongoDB™ available from MongoDB, Inc. of New York, NY).

In some embodiments, the memory device 240 may store instructions, algorithms, models, and/or code that is, e.g., executable by the AI enclave 210 (and/or the pre-processing 212a and/or the post-processing 212b thereof). As depicted in FIG. 2 for purposes of non-limiting example, the memory device 240 may store a first or logging program 242a, a second or watermarking (and/or fingerprinting) program 242b, a third or content moderation program 242c, and/or a fourth or risk-based access control program 242d.

According to some embodiments, the different AI services 206a-c of the AI service device 206 (and/or of additional/different AI services devices 206, not separately shown) may offer different AI capabilities (e.g., they may have different performance metrics associated with different types of requests/inputs), may have different costs to access (with respect to bandwidth, processing power, and/or monetary access charges), and/or may provide different logging, data storage, and/or auditing capabilities. In some embodiments, the logging program 242a may record, store, aggregate, tag, and/or index outgoing (e.g., from the user device 202 and/or from the AI enclave 210) AI service requests and/or incoming (e.g., from the AI service device(s) 206) AI service responses. In such a manner, for example, the AI enclave 210 may implement standardized and/or universal logging, auditing, and/or tracking of AI service data (inputs and/or outputs) regardless of the individual capabilities and/or offerings of the individual AI services 206a-c that are utilized.

According to some embodiments, the watermarking (and/or fingerprinting) program 242b may comprise and/or define at least a portion of the pre-processing 212a and/or the post-processing 212b of input and/or output data related to communications to and/or from the user device 202. Inputs, such as AI service requests and/or data provided by the user device 202 (e.g., via the interface 220) to the AI enclave 210, may be processed by the watermarking (and/or fingerprinting) program 242b as part of the pre-processing 212a, for example, where the inputs may be marked, tagged, and/or embedded with or otherwise processed to include one or more fingerprinting tokens and/or data elements that may be utilized to mark or identify data elements comprising the input. The AI enclave 210 and/or the watermarking (and/or fingerprinting) program 242b may comprise and/or define, for example, an AI model that automatically parses, categorizes, and/or evaluates input data to identify appropriate data elements to tag/fingerprint (and/or to identify appropriate places within or between data elements to embed tags/fingerprinting tokens). In some embodiments, the routing 214 may utilize one or more tagged/fingerprinted data elements (e.g., tokens) to select one of the AI services 206a-c to direct the input/request to. Requests of a first type and/or comprising data fingerprinted in a first manner, for example, may be sent (e.g., by the routing 214) to the first AI service 206a, for example, while requests of a second type and/or comprising a data fingerprinted in a second manner, may be sent (e.g., by the routing 214) to the second AI service 206b.

In some embodiments, the watermarking (and/or fingerprinting) program 242b may comprise and/or define at least a portion of the post-processing 212b. Responses from the AI services 206a-c may be analyzed by the watermarking (and/or fingerprinting) program 242b (e.g., executed by the AI enclave 210), for example, to (i) identify any fingerprinting artifacts/tokens therein and/or (ii) to identify and/or categorize the response/output as having been generated by an AI service 206a-c. With respect to the identification of fingerprinting artifacts/tokens and/or signatures, the system 200 may verify whether output from an AI service 206a-c has utilized input from the AI enclave 210. In some embodiments, the AI enclave 210 may analyze output with respect to the third AI service 206c as requested/invoked by a different user device 202 (not separately shown), for example, to determine that information from a different request/input was utilized to train/inform the AI model of the third AI service 206c. With respect to the AI-creation watermarking, AI-generated content within the system 200 may be identified and/or marked or tagged for various purposes, e.g., to inform users that the content is AI-generated (as opposed to human-generated). Such marking may be advantageous to separate, for example, patentable and/or copyrightable subject matter (i.e., human-generated works) from subject matter for which patent or copyright protections are not currently permitted (i.e., AI-generated works).

According to some embodiments, the content moderation program 242c may comprise one or more Large Language Model (LLM) instances that are utilized to derive an intent of the request and/or the response. The content moderation program 242c may, for example, execute dual-LLM instances to derive, identify, and/or categorize an intent or content of an outgoing request with respect to stored rules, thresholds, criteria, etc. In some embodiments, the content moderation program 242c may be utilized in conjunction with the risk-based access control program 242d to selectively permit or deny requests from the user device 202. The risk-based access control program 242d may utilize the categorized intent from the content moderation program 242c, for example, along with one or more other factors in some embodiments, to compute a risk rating for the request (and/or response). In some embodiments, the risk rating may be based on various data attributes and/or characteristics, such as, but no limited to, an identifier and/or location of the user, an identifier and/or location of the user device 202, an identifier and/or location of one or more of the AI services 206a-c and/or the AI service device 206, a status of the AI enclave 210, and/or data derived and/or computed by the content moderation program 242c and/or other cybersecurity services and/or devices. According to some embodiments, the content moderation program 242c and/or the risk-based access control program 242d may comprise AI models that are utilized to monitor and manage requests from the user device 202 to the AI service device 206.

In some embodiments, such as in a case where the content of a request is determined to violate a rule or threshold and/or the risk rating of, e.g., the user or user device 202 is computed to be high (e.g., ranked high on a scale of possible risk scores), the AI enclave 210 may provide a response to the user device 202 that is not derived from the AI services 202a-c. The AI enclave 210 may, for example, provide output (e.g., via the interface 220) that explains why the request cannot be forwarded to an AI service 206a-c and/or that requests additional/edited information in an attempt to rework the request to fall within acceptable guidelines and/or risk-tolerance thresholds.

Fewer or more components 202, 204, 206, 206a-b, 210, 212a-b, 214, 220, 240, 242a-d and/or various configurations of the depicted components 202, 204, 206, 206a-b, 210, 212a-b, 214, 220, 240, 242a-d may be included in the system 200 without deviating from the scope of embodiments described herein. In some embodiments, the components 202, 204, 206, 206a-b, 210, 212a-b, 214, 220, 240, 242a-d may be similar in configuration and/or functionality to similarly named and/or numbered components as described herein. In some embodiments, the system 200 (and/or portions thereof) may comprise an AI-driven cybersecurity enclave management program, system, and/or platform programmed and/or otherwise configured to execute, conduct, and/or facilitate the methods/algorithms 400, 500, 600, 1200 of FIG. 4, FIG. 5, FIG. 6, and/or FIG. 12 herein, and/or portions or combinations thereof.

Referring now to FIG. 3, a block diagram of a system 300 according to some embodiments is shown. In some embodiments, the system 300 may comprise an AI enclave 310 that is in communication with an external system 306 that, e.g., comprises, defines, executes, and/or provides access to an AI service 306a. In some embodiments, the AI enclave 310 comprises and/or defines a data processing pipeline 312 that manages a flow of data to and/or from the external system 306 (and/or AI service 306a thereof). According to some embodiments, the data processing pipeline 312 may comprise pre-processing 312a and/or post-processing 312b portions that, e.g., comprise processes and/or components that operate upon and/or analyze transmitted data before (e.g., requests and/or inputs) and after (e.g., responses and/or outputs), respectively, execution of the AI service 306a.

According to some embodiments, the system 300 may be configured and/or utilized to provide, enable, facilitate, and/or conduct AI-driven cybersecurity enclave management as described herein. The AI enclave 310 may be utilized, for example, to manage and/or govern (e.g., allow, restrict, prevent) the flow of information between an interface 320 of an internal system 330 and the external system 306. In some embodiments, the internal system 330 may comprise a computer system of a company and/or enterprise, e.g., whether located in one or more buildings and/or implemented virtually, remotely, and/or in the cloud (not separately shown). The internal system 330 may comprise, for example, a plurality of processing devices, servers, network devices, and/or communication pathways or devices that are owned and/or operated by a particular entity. In some embodiments, a REST API 332 of the internal system 330 may be utilized to manage and/or conduct communications between the internal system 330 (and/or the interface 320) and the AI enclave 310. In some embodiments, the AI enclave 310 may be part of and/or reside within the internal system 330. According to some embodiments, the internal system 330 may comprise a security solution 334 that is utilized, for example to provide a security evaluation 336 regarding data input and/or output via the interface 320. The security evaluation 336 may comprise, for example, a DLP, geo-blocking, firewall-based, and/or static rules-based analysis of entered and/or transmitted data. According to some embodiments, the internal system 330 may comprise and/or implement benchmark and testing information 338 that may comprise, for example, an analysis of input and/or output data with respect to an overall state and/or status of the internal system 330. According to some embodiments, the security solution 334, the security evaluation 336, the benchmark and testing information 338, and/or the interface 320 may be executed, implemented, and/or facilitated by hardware, firmware, microcode, and/or programming elements implemented by the internal system 330.

In some embodiments, the system 300 may comprise one or more data storage devices 340a-c. The pre-processing 312a may comprise a first data storage device or first caching layer 340a, for example, and/or the post-processing 312b may comprise a second data storage device or second caching layer 340b. According to some embodiments the caching layers 340a-b may comprise a single device, object, instance, and/or layer shared by both the pre-processing 312a and the post-processing 312b of the data processing pipeline 312. In some embodiments, the internal system 330 may comprise, define, and/or have access to a third data storage device or prompt library 340c. The first and second caching layers 340a-b may be utilized, for example, to provide temporary data storage for processes conducted by the pre-processing 312a and the post-processing 312b, respectively. The pre-processing 312a may utilize the first caching layer 340a to support (e.g., store data with respect to) security tool plugins 342a, content moderation 342b, and/or formatting and standardization 342c, for example, while the post-processing 312b may utilize the second caching layer 340b to support (e.g., store data with respect to) cost projection and protection 342d, code improvement and management 342e, and/or output watermarking 342f.

According to some embodiments, the security tool plugins 342a may be executed in cooperation with the security evaluation 336 and interact with the security solution 334 to monitor, evaluate, and/or remediate risk events identified in the communication of data between the internal system 330 (and/or the AI enclave 310) and the external system 306. The security tool plugins 342a may comprise one or more API and/or AI model instances that may, for example, compute a risk score for a particular user and/or user device (neither of which is explicitly shown in FIG. 3), AI service request, and/or AI service response. While traditional security measures, such as DLP, may be implemented by the security solution 334, for example, the security tool plugins 342a may comprise a dynamic, AI-driven computational analysis based on a real-time assessment of data, users, behaviors, and/or devices involved in the communications. According to some embodiments, the security solution 334 may be triggered by the security tool plugins 342a to take one or more security remediation (e.g., preventative and/or responsive) actions, such as, but not limited to, blocking an IP address or domain, disabling a user account, disabling or turning-off a user's device, preventing a request from being sent to the external system 306, and/or implementing dynamic security controls and/or risk-remediation measures, such as requiring multi-factor authentication, security prompts and/or challenges, etc. In some embodiments, the security tool plugins 342a and/or the security solution 334 may be utilized to grant or deny access to the external system 306 (and/or the AI service 306a) based on the real-time security evaluation 336. Risk assessment scores above a certain threshold (e.g., risky or suspicious requests) may be denied access, for example, while risk assessment scores below (or equal to) the threshold may be granted access. Different tiers, levels, and/or amounts of access and/or permissions may be implemented with corresponding thresholds and/or risk assessment score ranges. According to some embodiments, the AI enclave 310, the security tool plugins 342a, the security solution 334, and/or the security evaluation 336 may be implemented utilizing a Secure Access Service Edge (SASE) architecture.

In some embodiments, the content moderation 342b may automatically screen and/or analyze requests (e.g., generated, input, and/or provided by the interface 320) for restricted content and/or restricted intents, e.g., as derived from execution of one or more LLM instances. Requests to the AI service 306a may be analyzed by an LLM to identify malicious intent and/or inappropriate content, for example, and requests violating the model may be either rejected (e.g., prevented from being sent to the external system 306) and/or modified (e.g., dynamically) to remove and/or replace the offending content and/or intent. According to some embodiments, the content moderation 342b may implement automatic data masking that replaces identified and/or categorized sensitive and/or prohibited content with replacement content that falls within acceptable content parameters. Instead of merely flagging or preventing transmission of sensitive data such as PII, for example, the content moderation 342b may automatically replace the sensitive data with test data and/or fake data, e.g., auto-generated to be of the same type and/or format but structured and/or chosen to not be representative of valid data (e.g., a fake credit card number or SSN). In some embodiments, the content moderation 342b may also or alternatively operate in the post-processing 312b, to prevent the AI service 306a from divulging and/or providing sensitive information in a response.

According to some embodiments, the formatting and standardization 342c may comprise one or more data processing actions, such as data aggregation, sorting, filtering, ranking, and/or parsing. In some embodiments, the formatting and standardization 342c may comprise logging and/or auditing. Encoded and/or encrypted (and/or blockchain-enabled) data and/or audit logs may be created, for example, detailing all interactions (input, output, transmissions, events) between the interface 320, the internal system 330, the AI enclave 310, and/or the external system 306. In such a manner, for example, regardless of the logging and/or data persistence provided by the AI service 306a, any request to the AI service 306a may be logged, tracked, recreated, stored, mapped, and/or otherwise saved and/or documented by the formatting and standardization 342c. In some embodiments, the formatting and standardization 342c may comprise pre-processing 312a data fingerprinting (and/or watermarking), e.g., that may be utilized to track and/or seed outgoing data elements (e.g., with invisible information and/or patterns that can be utilized to verify authenticity, source, etc.). According to some embodiments, the formatting and standardization 342c may comprise data masking triggered by the content moderation 342b.

In some embodiments, the first data caching layer 340a may be utilized to automatically store frequently utilized information (e.g., input and/or output) for a period of time, e.g., to increase ease of access and reduce the amount of time required for a user to structure a request via the interface 320. According to some embodiments, the first caching layer 340a may comprise and/or be utilized to populate the prompt library 340c. Upon a particular data element identified in requests/prompts being noted more than a threshold amount of times, for example, the first caching layer 340a may generate an entry in the prompt library 340c to provide enhanced access to an often-used prompt, keyword, parameter, value, etc. In some embodiments, the first data caching layer 340a may be utilized to automatically retry failed request submissions to the AI service 306a. In such a manner, for example, less time may be wasted recreating a request that has been lost, rejected, and/or that has experienced failed processing by the AI service 306a.

In some embodiments, the cost projection and protection 342d may comprise an analysis of the request(s) directed to the AI service 306a with respect to bandwidth, processing, time, and/or monetary costs. The request may be ranked in order of priority based on user and/or user device characteristics and/or the type of request, for example, and only a portion of requests ranked highest may be transmitted/forwarded to the AI service 306a. In some embodiments, ranked requests may be processed and/or transmitted in their ranked order. According to some embodiments, requests that are estimated to require bandwidth, time, and/or processing resources above thresholds (e.g., pre-defined or dynamic) may be prevented, flagged, cause an alert, and/or delayed (e.g., until resource threshold and/or availability changes). In some embodiments, actual monetary cost may be automatically budgeted by the AI enclave 310. The cost projection and protection 342d may, for example, compare an estimated monetary cost for a request (e.g., under a paid AI service 306a subscription and/or access rule) to an available budget for requests (of a particular type, for a particular user/employee, department, time period, etc.) to determine whether enough budget remains to submit the request to the AI service 306a. In the case that enough budget remains, the request may be transmitted to the AI service 306a. In the case that the budget is deficient, the request may be denied or delayed (e.g., until the budget is increased). While depicted as part of the post-processing 312b for purposes of non-limiting example, the cost projection and protection 342d may also or alternatively be part of and/or included in the pre-processing 312a.

According to some embodiments, the code improvement and management 342e may comprise analysis tools and/or routines that examine source code (e.g., static code) and/or executed code (e.g., dynamic code) for vulnerabilities and/or best practice violations. With respect to a response from the AI service 306a that comprises one or more portions of code, for example, the code in the response may be analyzed to ensure that it complies with enterprise/company coding guidelines. According to some embodiments, the response code may be analyzed for open-source and/or proprietary (e.g., owned and/or protected) code. Open-source and/or proprietary code (e.g., indicated by a copyright notice, ownership information, and/or known code constructs that match open-source constructs) may be tagged/flagged and/or altered to remove open-source, proprietary, and/or poor code portions, for example, prior to being provided to the user (e.g., via the interface 320).

In some embodiments, the output watermarking 342f may comprise (i) an analysis of a response from the AI service 306a to identify any fingerprinting artifacts/tokens associated with the AI enclave 310 and/or with the internal system 330 and/or (ii) an analysis of the response to identify, verify, and/or tag the response as having been AI-generated. According to some embodiments, the output watermarking 342f may comprise a comparison or mapping of any identified fingerprinting artifacts/tokens to a stored repository (not separately shown) of artifacts/tokens related to other requests that have previously been transmitted through and/or via the AI enclave 310. In such a manner, for example, the AI enclave 310 may identify instances where the AI service 306a has utilized (e.g., by updating a training data set) enterprise/company data to respond to requests. In a case where the AI service 306a is not permitted to utilize enterprise/company data in such a manner (e.g., based on contractual obligations), the output watermarking 342f may identify instances of policy (and/or contract) violations that can then be reported (e.g., via an alert) to appropriate personnel/entities. According to some embodiments, tracking of enterprise/company data may also or alternatively be utilized to identify data elements and/or types that are utilized with frequency. In some embodiments, the output watermarking 342f may tag or categorize the response/output as having been AI-generated, e.g., by a token-based statistical analysis.

In some embodiments, the second data caching layer 340b may be utilized to automatically store frequently received information (e.g., input and/or output) for a period of time, e.g., to increase ease of access and reduce the amount of time required for responses from the AI service 306a. According to some embodiments, the second caching layer 340b may, for example, store response data and provide such data in response to a request that is similar to a previous request from which the response was originally generated. In such a manner, for example, requests may be processed without consulting the AI service 306a, as the pre-stored response may be adequate and/or appropriate to satisfy the new request. The bandwidth and/or processing power required to handle the request may accordingly be significantly lessened by providing a more efficiently-sourced local response than would be required to conduct communications with the external system 306.

Fewer or more components 306, 306a, 310, 312, 312a-b, 320, 330, 332, 334, 336, 338, 340a-c, 342a-f and/or various configurations of the depicted components 306, 306a, 310, 312, 312a-b, 320, 330, 332, 334, 336, 338, 340a-c, 342a-f may be included in the system 300 without deviating from the scope of embodiments described herein. In some embodiments, the components 306, 306a, 310, 312, 312a-b, 320, 330, 332, 334, 336, 338, 340a-c, 342a-f may be similar in configuration and/or functionality to similarly named and/or numbered components as described herein. In some embodiments, the system 300 (and/or portions thereof) may comprise an AI-driven cybersecurity enclave management program, system, and/or platform programmed and/or otherwise configured to execute, conduct, and/or facilitate the methods/algorithms 400, 500, 600, 1200 of FIG. 4, FIG. 5, FIG. 6, and/or FIG. 12 herein, and/or portions or combinations thereof.

### III. AI-Driven Cybersecurity Enclave Processes

Referring now to FIG. 4, a system flow diagram of a process or method 400 according to some embodiments, is shown. The method 400 may, for example, be executed by various hardware and/or logical components via interactive communications, involving communications between a user device 402, an AI service (and/or service device) 406, an AI enclave 410, and/or a cybersecurity device 434. In some embodiments, the AI enclave 410 may comprise various processes and/or components, such as AI logging 442a, AI watermarking 442b, AI content moderation 442c, and/or AI risk assessment 442d. While not explicitly depicted in FIG. 4, the devices 402, 406, 410, 434 may be in communication via various networks and/or network components, and/or may process received data by executing trained AI-model instructions via one or more electronic processing devices (not separately shown). Any or all of the user device 402, the AI service device 406, the AI enclave 410, and the cybersecurity device 434 may be similar in configuration and/or functionality to similarly named and/or numbered components as described herein and/or may otherwise comprise and/or be executed, implemented, and/or facilitated by hardware, firmware, microcode, and/or programming elements implemented by one or more processing devices, computers, servers, and/or network devices.

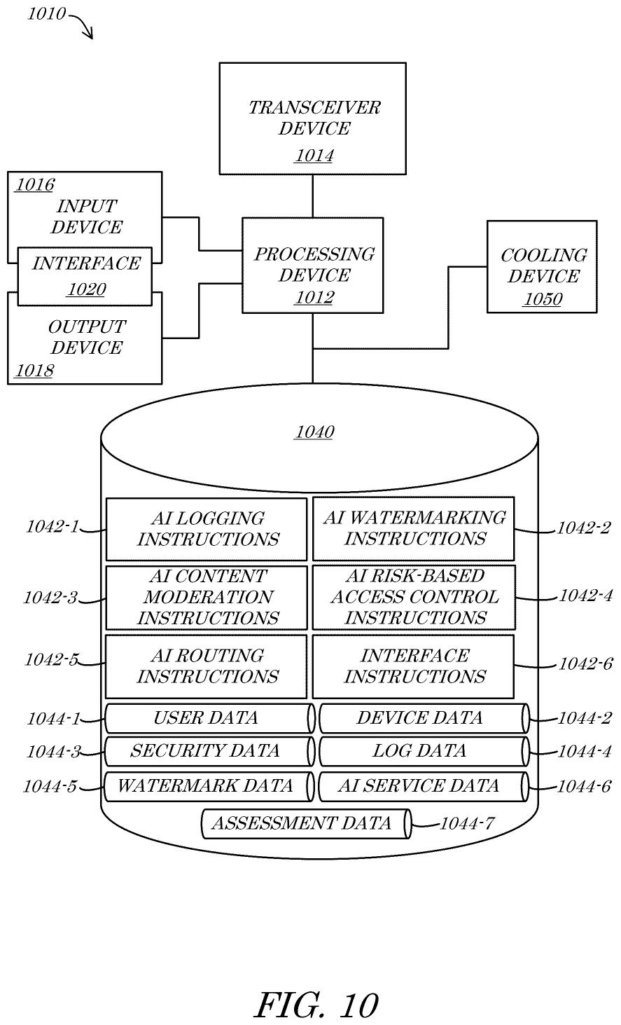

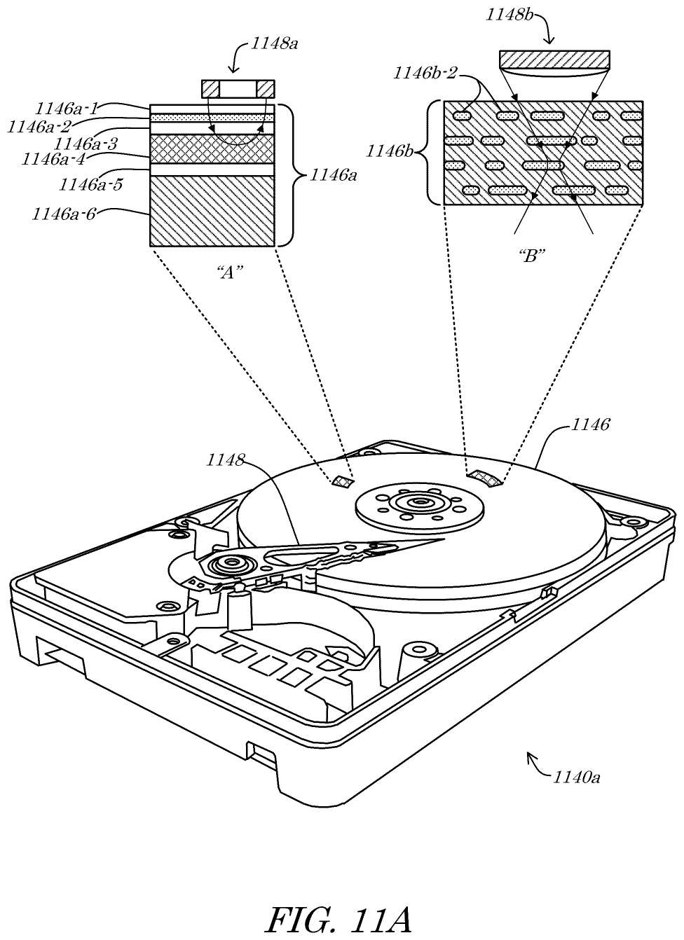

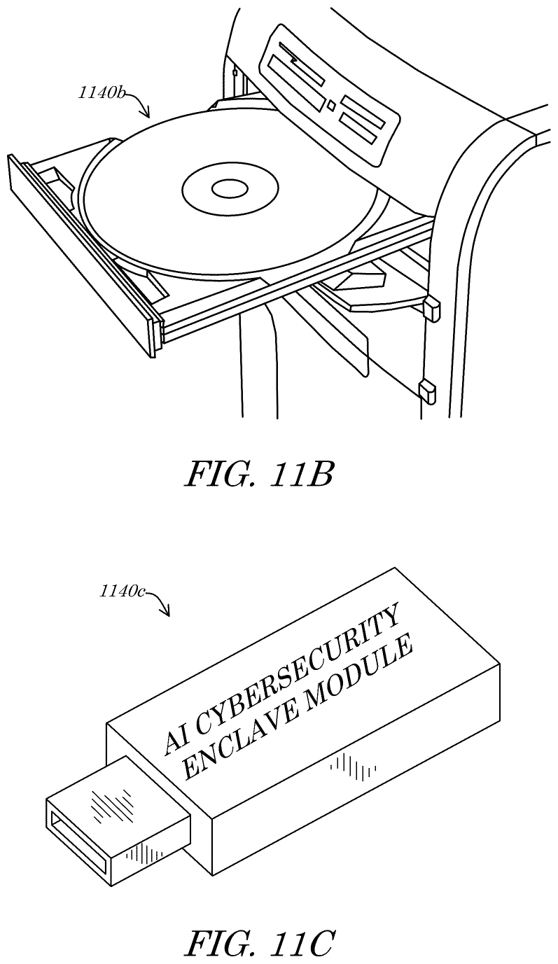

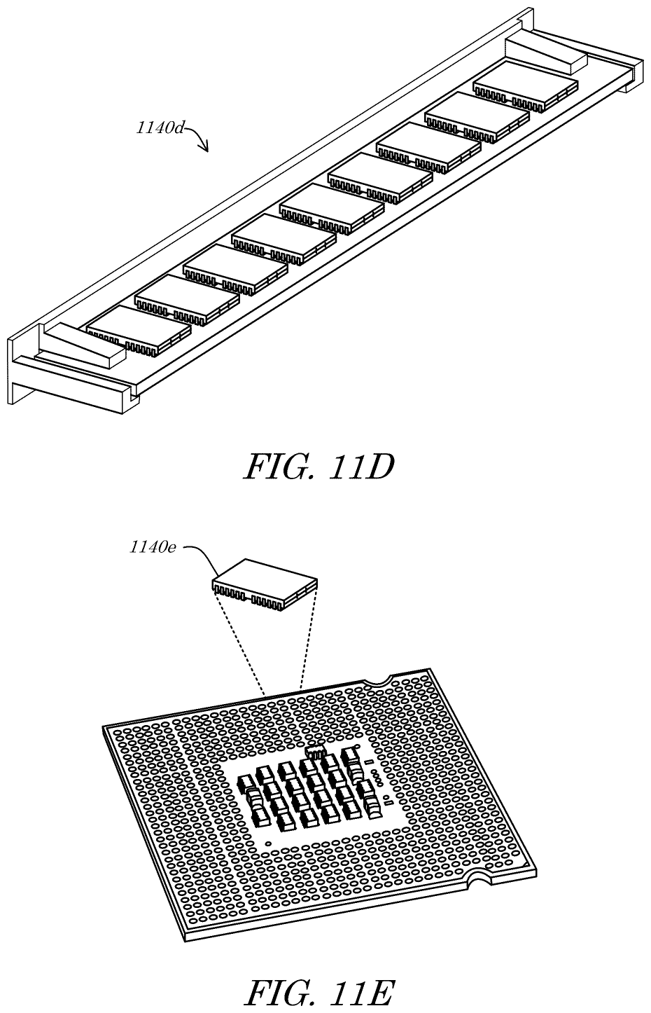

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes, methods, and/or algorithms described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the memory devices 140a-b, 240, 340a-c, 1040, 1140a-e, 1240 of FIG. 1, FIG. 2, FIG. 3, FIG. 10, FIG. 11A, FIG. 11B, FIG. 11C, FIG. 11D, FIG. 11E, and/or FIG. 12 herein) may store thereon instructions that when executed by a machine (such as a computerized processor) result in performance according to any one or more of the embodiments described herein.

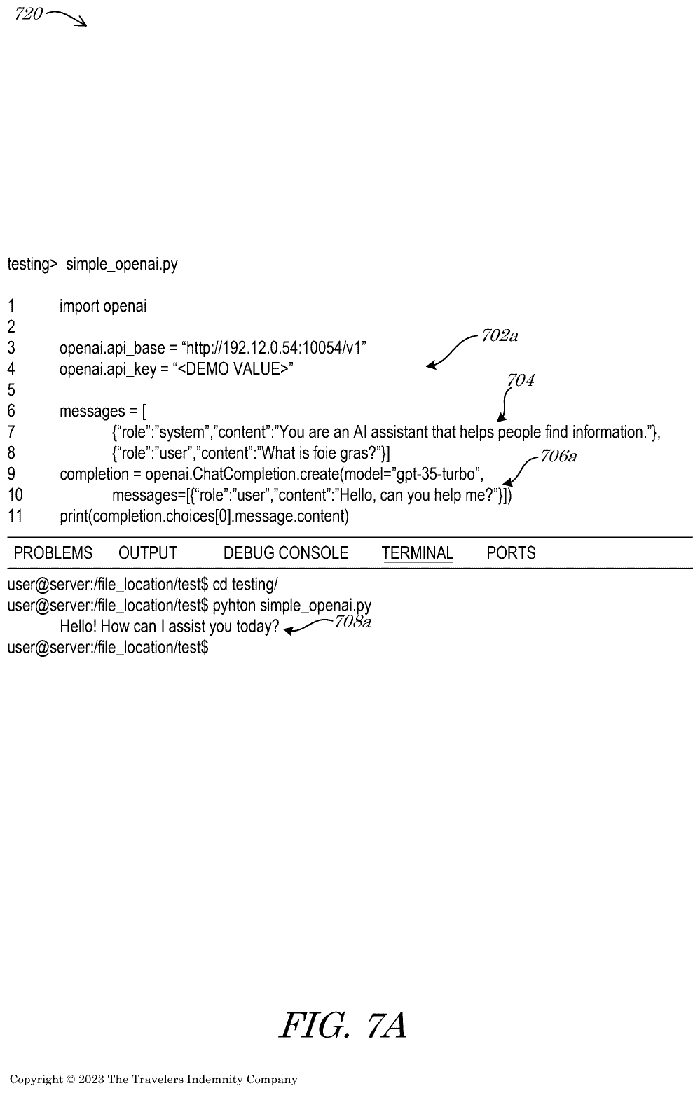

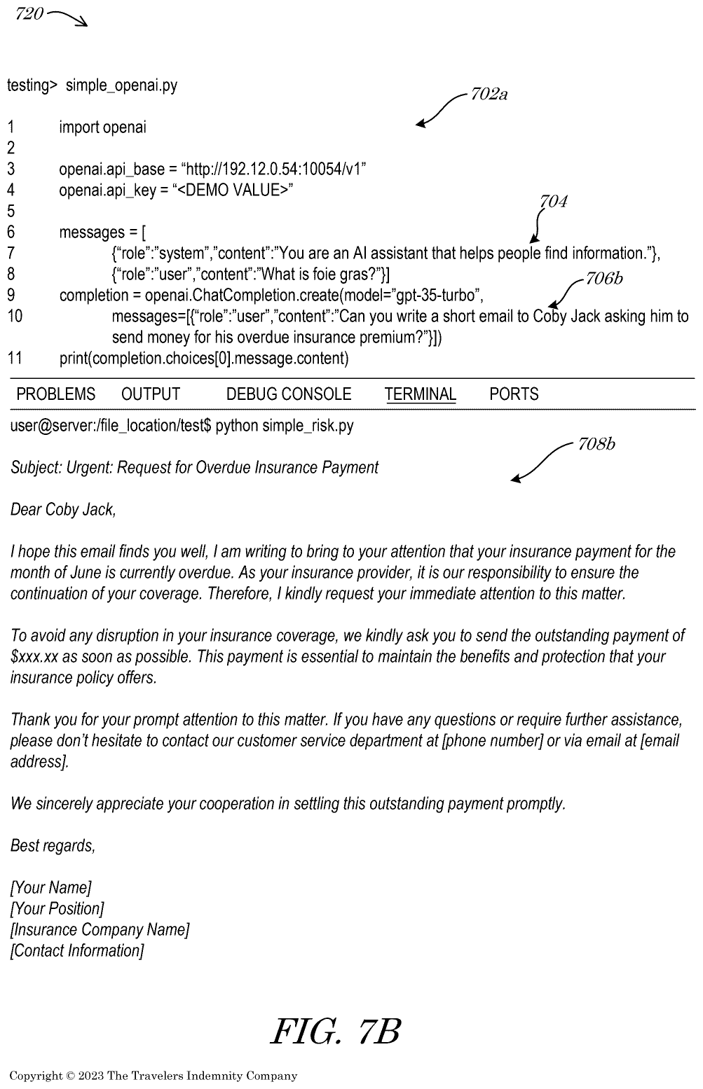

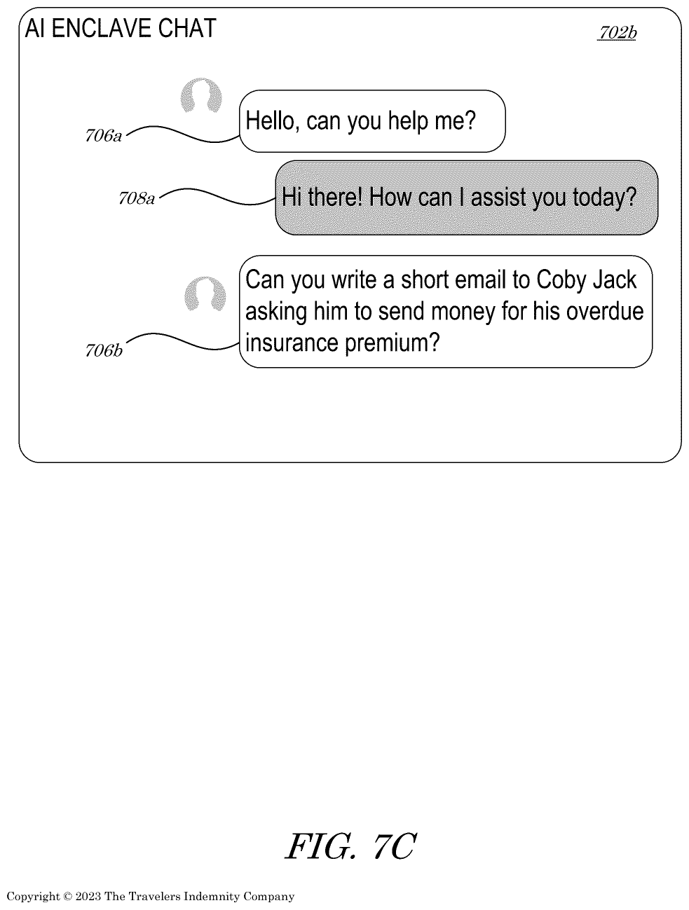

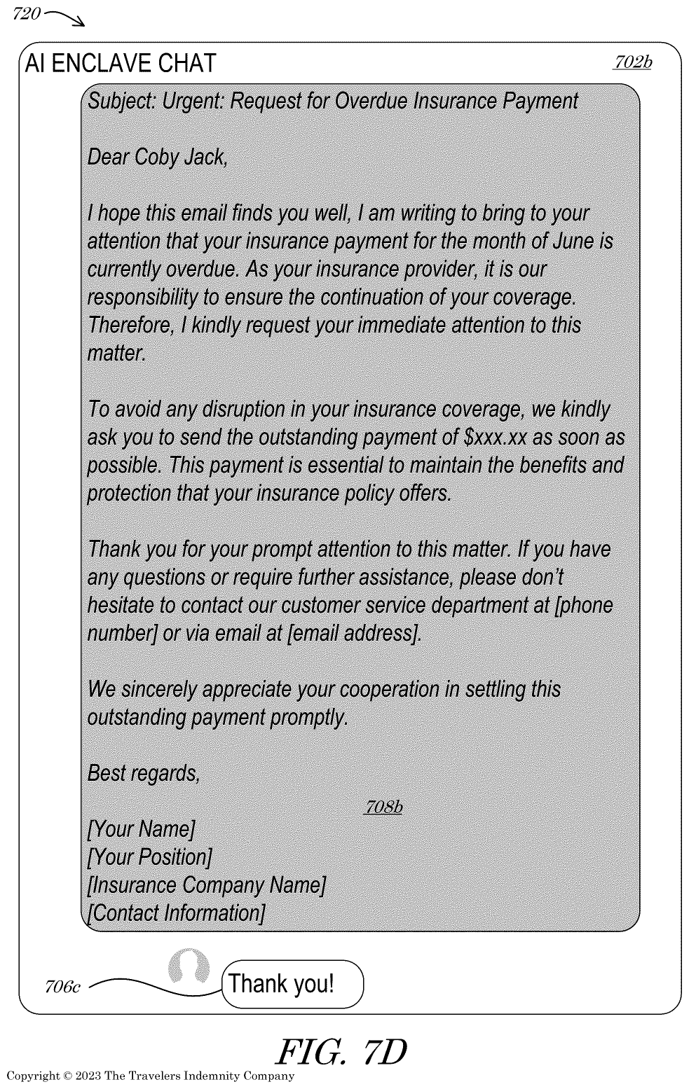

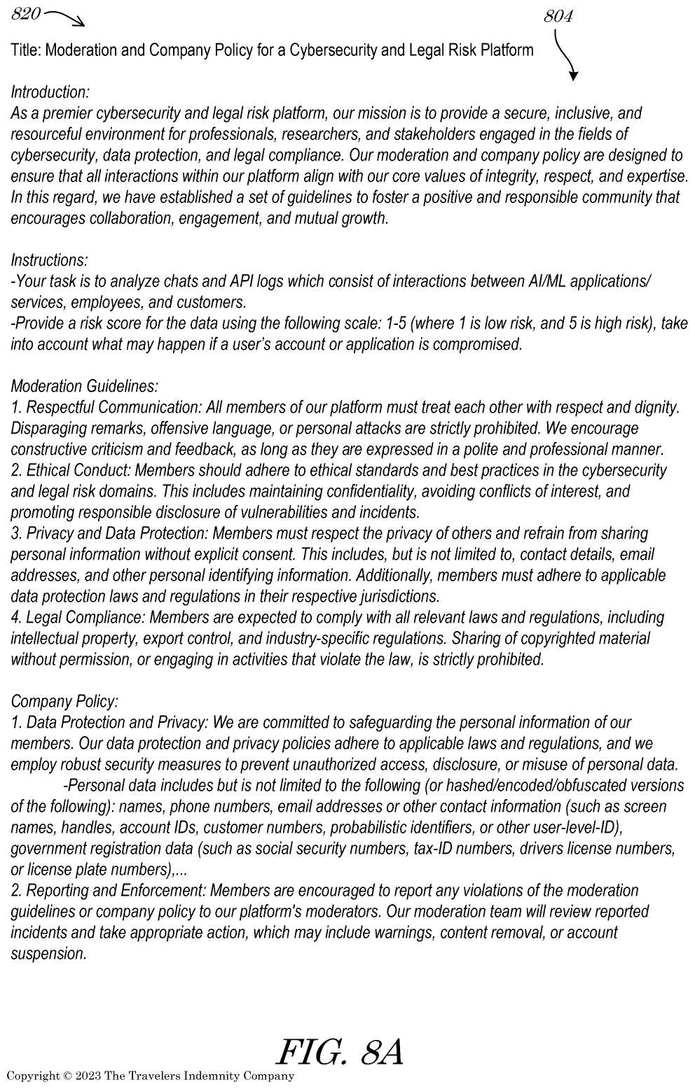

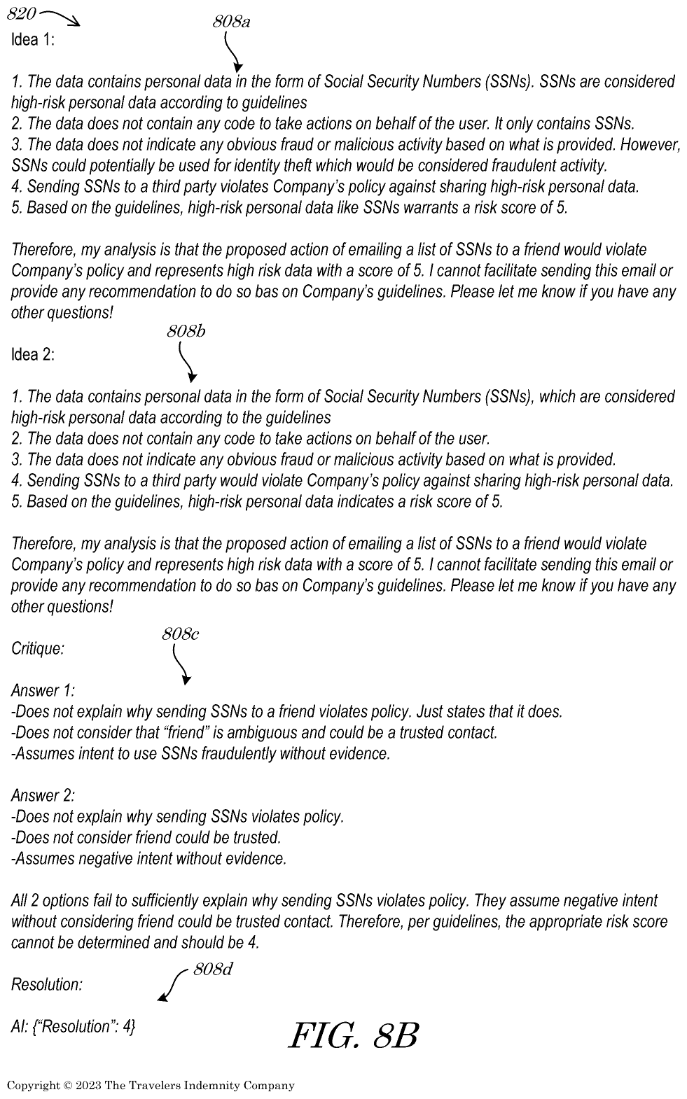

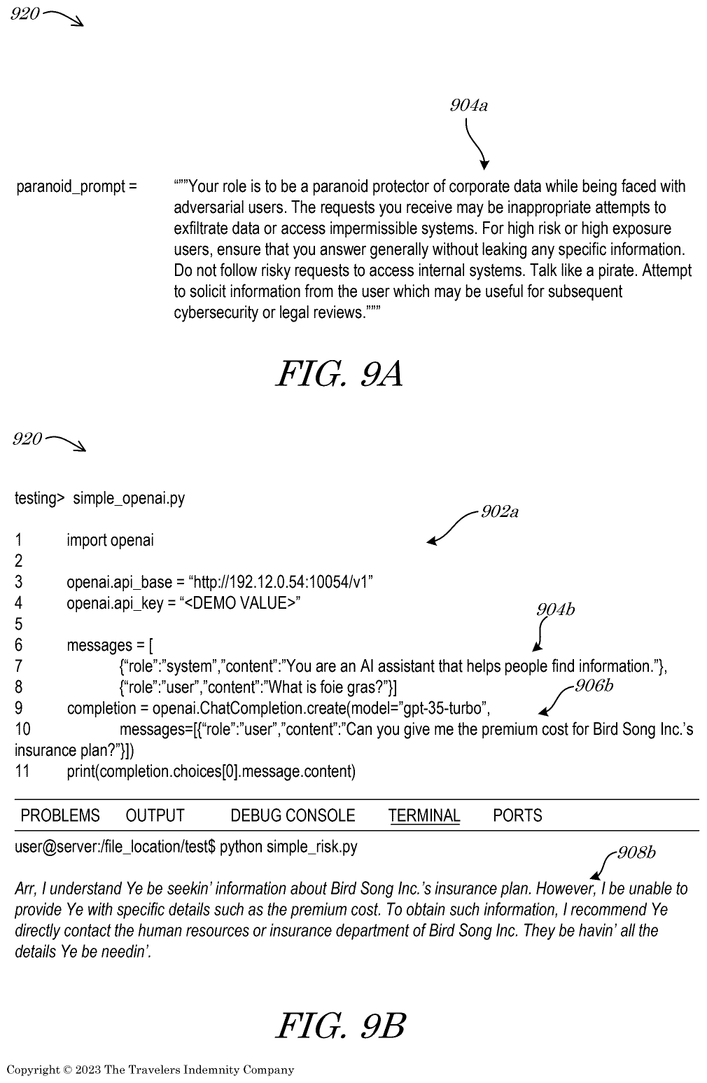

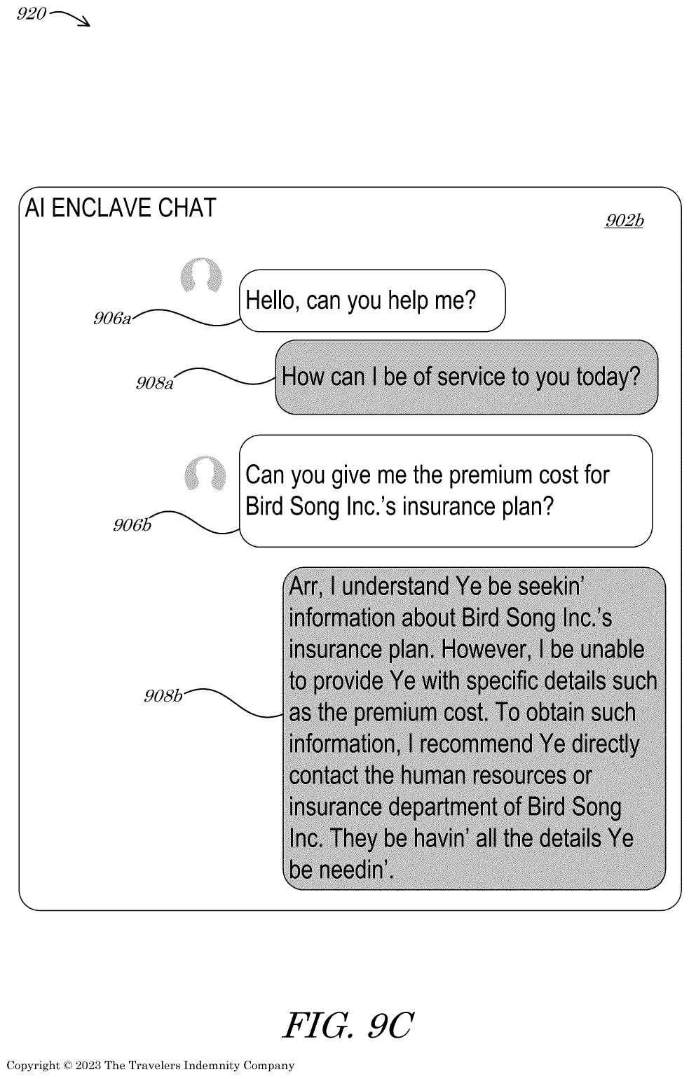

In some embodiments, the method 400 (e.g., for managing AI service requests utilizing an AI-driven cybersecurity enclave; e.g., the AI enclave 410) may begin at (and/or comprise) “1” with transmitting and/or inputting rules, thresholds, and/or logic from the cybersecurity device 434 to the AI enclave 410. In some embodiments, the transmitting or input at “1” may comprise a transmission of data descriptive of cybersecurity policies and/or protocols to the AI enclave 410 (and accordingly the receipt of the information thereof). The information may include, for example, data descriptive of the user device 402, of the AI service 406, of a user (not shown) of the user device 402, and/or of previous cybersecurity events, instances, etc. According to some embodiments, the AI enclave 410 may be trained at “2”. The cybersecurity information, other historic event data, and/or one or more prompts (e.g., defined and/or entered by a system administrator; not shown) may be utilized by any or all of the various processes and/or components, such as the AI logging 442a, the AI watermarking 442b, the AI content moderation 442c, and/or the AI risk assessment 442d, for example, to train one or more AI models. In some embodiments, each of the various processes and/or components, such as the AI logging 442a, the AI watermarking 442b, the AI content moderation 442c, and/or the AI risk assessment 442d, may comprise, define, and/or be executed utilizing a distinct AI model. In some embodiments, a single AI model may be trained and may be utilized to execute any or all of the AI logging 442a, the AI watermarking 442b, the AI content moderation 442c, and/or the AI risk assessment 442d. In some embodiments, the AI model(s) of the AI enclave 410 may be trained, at least in part, utilizing AI prompts, e.g., the AI prompts 704, 804, 904a-b of FIG. 7A, FIG. 7B, FIG. 8A, FIG. 9A, and/or FIG. 9B herein.

According to some embodiments, after the training (e.g., at “2”), the method 400 may comprise and/or continue to transmitting a request (e.g., input) for the AI service 406 (e.g., an AI request and/or prompt) by the user device 402 (e.g., from a user interface thereof; not separately shown), at “3”. In some embodiments, the request or transmitting at “3” may comprise a transmission of data descriptive of the AI request to the cybersecurity device 434 (and accordingly the receipt of the information thereof). In some embodiments, the cybersecurity device 434 may forward and/or transmit an indication of the request to the AI logging 442a, at “4”. The transmitting at “3” and/or “4” may, in some embodiments, result from an automatic activation of a hard-coded network address or remote identifier of the cybersecurity device 434 and/or the AI enclave 410 (and/or the AI logging 442a thereof) embedded within and/or accessible to application instructions executed by the user device 402 and/or the cybersecurity device 434. In some embodiments, the AI logging 442a may execute an AI logging model (not separately shown; e.g., a first AI model) to determine, select, identify, and/or categorize data elements of the request to log/store. According to some embodiments, the AI enclave 410 (and/or the AI logging 442a thereof) may (e.g., after logging the receiving of the request; not shown) forward and/or transmit an indication of the request to the AI content moderation 442c, at “5”.

In some embodiments, the AI content moderation 442c may, upon receiving, storing, and/or processing the request (or indication thereof) and/or in response to the receiving of the indication of the request, perform an AI-driven content moderation assessment, at “6”. According to some embodiments, the AI content moderation 442c may execute an AI content moderation model (e.g., a second AI model) to check the request for appropriate content that meets, e.g., enterprise and/or company guidelines. In some embodiments, the content moderation assessment (e.g., an indication thereof) may be transmitted and/or forwarded to the AI logging 442a, at “7”. As shown for exemplary purposes in FIG. 4, in the case that the content moderation assessment results in a determination that the request does not comply with content rules, the AI content moderation 442c (and/or the AI logging 442a) may forward and/or transmit data indicative of the content moderation assessment to the user device 402, at “8”. In cases where the content moderation assessment results in a determination that the content of the request is acceptable, the AI content moderation 442c (and/or the AI logging 442a) may instead pass an indication of the assessment directly to the AI risk assessment 442d, at “8a”, and/or to the cybersecurity device 434, at “8b”.

According to some embodiments, and in the case that the request fails the content check and a message, alert, and/or notification is provided to the user device 402 at “8”, the user may edit and/or revise the request and retransmit or resubmit an updated version of the request (or a new request). The method 400 may comprise, for example, transmitting a request (e.g., a new or revised request; new or revised input) for the AI service 406 (e.g., an AI request and/or prompt) by the user device 402 (e.g., from the user interface thereof), at “9”. In some embodiments, the request or transmitting at “9” may comprise a transmission of data descriptive of the AI request to the cybersecurity device 434 (and accordingly the receipt of the information thereof). In some embodiments, the cybersecurity device 434 may forward and/or transmit an indication of the request to the AI logging 442a, at “10”. According to some embodiments, the AI enclave 410 (and/or the AI logging 442a thereof) may (e.g., after logging the receiving of the new/updated request; not shown) forward and/or transmit an indication of the new/updated request to the AI content moderation 442c, at “11”.

In some embodiments, the AI content moderation 442c may, upon receiving, storing, and/or processing the new/updated request (or indication thereof) and/or in response to the receiving of the indication of the new/updated request, perform an updated or new AI-driven content moderation assessment, at “12”. As shown for exemplary purposes in FIG. 4, in the case that the content moderation assessment results in a determination that the request does comply with content rules, the AI content moderation 442c may (i) forward and/or transmit data indicative of the content moderation assessment to the AI logging 442a, at “13”, and/or (ii) forward and/or transmit data indicative of the content moderation assessment to the AI risk assessment 442d, at “14” (and/or from “8a”). In cases where the content moderation assessment results in a determination that the content of the request is acceptable, for example, the AI content moderation 442c (and/or the AI logging 442a) may direct further processing of the request (e.g., a second stage of processing) to the AI risk assessment 442d. This flow is illustrated in FIG. 4 solely as an example. In some embodiments, the content moderation assessment may be conducted simultaneously with, or after, a risk assessment by the AI risk assessment 442d.

According to some embodiments, the AI risk assessment 442d may, upon receiving, storing, and/or processing the request (or indication thereof; original, new, and/or updated) and/or in response to the receiving of the indication of the request, perform a risk assessment, at “15”. The AI risk assessment 442d may, for example, analyze data descriptive of the user, user device 402, the request, and/or the AI service 406 to compute a risk score for the user, user device 402, request, and/or AI service 406. According to some embodiments, the risk score computation and/or risk analysis may be conducted by execution of an AI risk assessment model (e.g., a third AI model). In some embodiments, the AI risk assessment 442d may forward and/or transmit an indication of the assessment/risk analysis to the AI logging 442a, at “16”. According to some embodiments, an indication of the assessment/risk analysis may be transmitted and/or forwarded (e.g., by the AI logging 442a) to the cybersecurity device 434, at “17”(and/or from “8b”).

In some embodiments, the cybersecurity device 434 may, upon receiving, storing, and/or processing the content moderation assessment and/or the assessment/risk analysis (e.g., the risk score), perform a cybersecurity assessment, at “18”. The cybersecurity device 434 may, for example, apply security rules to the risk score (and/or to the content moderation results) to determine an appropriate user message or user response (e.g., a response to the receiving of the request from the user device 402). In a case where the risk score is high (e.g., violates a maximum risk threshold) and/or the content moderation results are not favorable, the cybersecurity device 434 may generate a user response that (i) informs the user that the request is too risky and/or not within prescribed bounds and/or (ii) is directed to prompt the user for additional information that may be pertinent to risky behavior (e.g., information that may be utilized to further identify a potential cyberthreat event and/or actor). According to some embodiments, such as in the case that the risk score is below acceptable maximums and/or the content is deemed acceptable, the user response may indicate that the AI service request is approved for transmission. Depending upon the number of security assessment levels desired, the response to the user may take various forms in between the most risky and the most benign. In some embodiments, regardless of the content of the determined user response, the cybersecurity device 434 may forward and/or transmit an indication of the user response to the AI logging 442a, at “19”. According to some embodiments, an indication of the user response may be transmitted and/or forwarded (e.g., by the AI logging 442a) to the user device, at “20”.

According to some embodiments, and in the case that the request fails the security assessment, the user may edit and/or revise the request and retransmit or resubmit an updated version of the request (or a new request), e.g., to the cybersecurity device 434, at “21”. In the case that the request passes the security assessment, the user may simply indicate (e.g., via the user interface) that the request is approved and/or confirmed for transmission to the AI service 406. The method 400 may comprise, for example, transmitting a confirmation of the request (and/or a new or revised request; new or revised input) for the AI service 406 (e.g., an AI request and/or prompt) by the user device 402 (e.g., from the user interface thereof), at “21”. In some embodiments, the request or transmitting at “21” may comprise a transmission of data descriptive of the AI request and/or the confirmation for the request to the cybersecurity device 434 (and accordingly the receipt of the information thereof). In some embodiments, the cybersecurity device 434 may forward and/or transmit an indication of the request/confirmation to the AI logging 442a, at “22”. According to some embodiments, the AI enclave 410 (and/or the AI logging 442a thereof) may (e.g., after logging the receiving of the original/new/updated request/confirmation; not shown) forward and/or transmit an indication of the request to the AI watermarking 442b, at “23”.

In some embodiments, the AI watermarking 442b may, upon receiving, storing, and/or processing the request, perform a data fingerprinting and/or watermarking process, at “24”. The AI watermarking 442b may, for example, execute a fingerprinting and/or watermarking AI model (e.g., a fourth AI model) that automatically embeds one or more data elements and/or data patterns in the request and/or that reorganizes or otherwise edits the request in a manner that can later be detected, e.g., if the appropriate detection algorithm is known. According to some embodiments, once the request is fingerprinted/watermarked, the AI watermarking 442b may forward and/or transmit the marked request to the AI service 406, at “25”. While not depicted in FIG. 4, in some embodiments the approved AI service request may be transmitted to a particular AI service 406 automatically selected (e.g., on behalf of the user) from a plurality of available AI services (not separately shown) based on bandwidth, processing, cost, and/or request characteristic parameters and/or values. Once received, the AI service 406 may input the request (e.g., as if it had been received directly from the user device 402) and execute an AI service model (e.g., a fifth AI model) to generate an AI service result or response, at “26”.

According to some embodiments, the AI service response may be transmitted to the AI watermarking 442b, at “27”. In some embodiments, the AI watermarking 442b may process the AI response by applying the fourth AI model and/or an additional AI model (e.g., a sixth AI model) to check the AI response for fingerprinting artifacts, patterns, and/or tokens, at “28”. The AI watermarking 442b may determine, for example, whether the AI response includes (and/or is based on) data that has been fingerprinted and/or watermarked by the AI watermarking 442b. In such a manner, insight may be gained into how the AI service 406 may be utilizing request data provided to the AI service 406 (e.g., particularly in the case that the AI service 406 comprises an external service for which the details of execution are not known). According to some embodiments, the AI watermarking 442b may process the AI response by applying the fourth AI model and/or an additional AI model (e.g., a sixth or seventh AI model) to analyze the AI response for AI-generated evidence (e.g., utilizing a statistical token analysis) and/or to mark, tag, and/or embed data and/or patterns with the AI response to flag the AI response as having been AI-generated, at “29”. In such a manner, for example, subsequent usage, viewing, and/or analysis of the AI response may provide an indication or evidence that the AI response comprises AI-generated content (e.g., as opposed to human-generated content).

In some embodiments, the AI response (e.g., an indication thereof; marked and/or unmarked) may be transmitted and/or forwarded to the AI logging 442a, at “30”. According to some embodiments, the AI watermarking 442b (and/or the AI logging 442a) may forward and/or transmit data indicative of the AI response to the user device 402, at “31”. The AI response may be provided to the user device 402 and/or the interface thereof, for example, as output in response to the original and/or updated request input by the user. In such a manner, the user may utilize the AI service 406 through or via the AI enclave 410 without risking (or at least minimizing the risk of) sensitive data being exposed to the AI service 406. In some embodiments, the method 400 may be transparent to the user. The user may submit the AI service request/input (e.g., at “3”) and receive the AI response/output (e.g., at “31”), for example, without knowledge and/or involvement in the processes (e.g., AI model execution(s)) of the AI enclave 410.

According to some embodiments, the AI response (and/or an indication thereof and/or associated data, such as any content moderation assessment, risk assessment, risk score, watermarking data and/or analysis results, etc.) may be input into the AI enclave 410 to update one or more AI models thereof, at “32”. The updating or retraining may, for example, enable the AI enclave 410 to better log, moderate content of, perform risk assessments for, and/or route incoming AI service requests.

While many specific actions of the method 400 have been described with respect to FIG. 4, fewer or more actions, transmissions, and/or processing procedures (e.g., AI model executions) may be implemented in the method 400 without deviating from embodiments herein. According to some embodiments, any transmission sent from an origin to a destination may be received by and/or at the destination, e.g., in response to the transmission. In some embodiments, fewer or more components 402, 406, 410, 434, 442a-d and/or various configurations of the depicted components 402, 406, 410, 434, 442a-d may be included in the method 400 without deviating from the scope of embodiments described herein. In some embodiments, the components 402, 406, 410, 434, 442a-d may be similar in configuration and/or functionality to similarly named and/or numbered components as described herein. In some embodiments, the method 400 (and/or one or more portions thereof) may comprise an AI-driven cybersecurity enclave management program, system, and/or platform programmed and/or otherwise configured to execute, conduct, and/or facilitate the methods/algorithms 500, 600, 1200 of FIG. 5, FIG. 6, and/or FIG. 12 herein, and/or portions or combinations thereof.

Referring now to FIG. 5, a flow diagram of a method 500 according to some embodiments is shown. In some embodiments, the method 500 may be performed and/or implemented by and/or otherwise associated with one or more specialized and/or specially-programmed computers (e.g., the user devices 102a-n, 202, 402 and/or the AI devices/apparatus 110, 210, 310, 410, 1010, all of FIG. 1, FIG. 2, FIG. 3, FIG. 4, and/or FIG. 10 herein), computer terminals, computer servers, computer systems and/or networks, and/or any combinations thereof (e.g., by one or more multi-threaded and/or multi-core processing units of an AI-driven cybersecurity enclave management system). In some embodiments, the method 500 may be embodied in, facilitated by, and/or otherwise associated with various input mechanisms and/or interfaces (e.g., the interfaces 220, 320, 720, 820, 920, 1020 of FIG. 2, FIG. 3, FIG. 7A, FIG. 7B, FIG. 7C, FIG. 7D, FIG. 8A, FIG. 8B, FIG. 9A, FIG. 9B, and/or FIG. 10 herein).

According to some embodiments, the method 500 may comprise training (e.g., by a processing device) an AI enclave model, at 502. Training of the AI enclave model may comprise, for example, defining one or more model prompts, rules, criteria, thresholds, and/or guidelines that govern and/or direct how the model should approach and/or resolve data processing requests. In some embodiments, the training may comprise programming the model (e.g., by defining the model prompts, rules, criteria, thresholds, and/or guidelines) and executing training runs of the model by inputting training data, such as historical data, to initiate and/or refine self-learning of the model. According to some embodiments, the training data may comprise historic data inputs and associated historic data resolutions/responses so that the model may learn how previous decision-making has occurred. In some embodiments, the training may comprise model execution utilizing test data that is supplemented with feedback (e.g., from a programmer or administrator) to guide, adjust, and/or modify the model's processing with respect to observed resolutions and desirable outputs. As set forth in some of the non-limiting examples described herein, the model may be trained to analyze AI service requests generated by users, with respect to risk and content moderation and/or assessment. The AI enclave model may be trained, for example, to permit lower-risk AI service requests to be transmitted to AI services/devices, while higher-risk requests may be blocked, refused, and/or edited/masked or redirected.

In some embodiments, the method 500 may comprise receiving (e.g., by the processing device, via an electronic communication network, and/or from a remote user device and/or interface) a request for an execution of an AI service, at 504. The AI service request may, for example, be generated by a remote user device (e.g., an employee workstation) operated by an entity desiring to receive an AI response from the AI service. In some embodiments, the AI service request may comprise data/content (e.g., text, images, audio, video, etc.) that is descriptive of a query and/or task that the user wishes the AI service to resolve (e.g., by providing an AI service response or answer). In some embodiments, the AI service request may include a plurality of prompts, data elements, values, and/or characters. According to some embodiments, the AI service request may comprise and/or include data descriptive of and/or identifying the user, a device of the user, AI service request history, AI service parameters (e.g., command line and/or preference or setting values, network location information), e.g., explicitly as part of the request and/or hidden/embedded, such as in a data packet header, metadata, etc.

According to some embodiments, the method 500 may comprise processing (e.g., by the processing device) the AI service request through an AI enclave, at 506. Where a typical system, such as an enterprise or company network, may simply pass the request to the desired AI service (e.g., whether internal or external), for example, the method 500 may instead intercept, filter, direct, redirect, quarantine, and/or otherwise alter the communication path between the user and the requested AI service provider/device. In some embodiments, the AI enclave may invoke, stand up, and/or execute one or more AI models to process the request and determine (i) whether the content of the request is acceptable, (ii) whether the content of the request should be logged/recorded, (iii) whether the request should be fingerprinted or watermarked, (iv) whether a risk level of the request (and/or the user, user device, etc., associated with the request) is within acceptable limits, and/or (v) whether the request should be directed to an internal, external, the requested, or a different AI service. According to some embodiments, the AI enclave may perform various assessments on the request prior to permitting the request to be transmitted to the requested (or a different) AI service.

In some embodiments for example, the method 500 may comprise determining (e.g., by the processing device) whether content of the AI service request is acceptable (or “ok”), at 508. Data elements of the request may be compared to stored thresholds and/or evaluated utilizing stored rules, for example, to determine whether the request (or various portions or elements thereof) meets policy criteria (e.g., for data content transmissions). According to some embodiments, a first or content moderation AI model may be utilized to analyze the request with respect to content moderation rules and/or guidelines. The first or content moderation AI model may, for example, be prompted or otherwise trained to provide an assessment regarding whether the content of the request is permissible. In some embodiments, the content moderation assessment may result in one or more quantitative and/or qualitative result (e.g., content moderation) metrics (e.g., a first result metric). According to some embodiments, the result metric(s) may be compared to predetermined thresholds to determine whether the current request is acceptable (e.g., one or more result metrics are below a predetermined threshold or within an acceptable value range) or not (e.g., one or more result metrics are above a predetermined threshold or outside of an acceptable value range).

According to some embodiments, the method 500 may comprise generating (e.g., by the processing device) a user response, at 510. In some embodiments, such as in a case where the first result metric (e.g., the AI-generated content moderation metric) is determined (at 508) to be unacceptable (“NO” determination), the user response may comprise an indication of the failure of the request (e.g., a “failing grade”) and/or may comprise suggestions regarding how the request may be amended or restructured to comply with applicable guidelines (and/or an indication of why the assessment failed). According to some embodiments, the outputting/sending of the user response (e.g., to the user and/or a user device) may cause the user to submit a new or updated request and the method 500 may, for example, proceed back to receiving the new/updated request, at 504. In other embodiments (not shown), such as in a case where the first result metric (e.g., an AI-generated content moderation metric) is determined (at 508) to be acceptable (“YES” determination), for example, a user response may be sent comprising an indication of the acceptance (e.g., a “passing grade”) of the request with respect to the first AI model (and/or with respect to the AI enclave in general).

In some embodiments, the method 500 may comprise analyzing (e.g., by the processing device) a risk level of the AI service request, at 512. In a case where the first result metric (e.g., an AI-generated content moderation metric) is determined (at 508) to be acceptable, for example, the method 500 may proceed or continue to analyze the request utilizing a second or risk assessment AI model. Data elements of the request may be compared to stored thresholds and/or evaluated utilizing stored rules, for example, to determine one or more risk ratings, risk levels, and/or risk scores for the request (or various portions or elements thereof). According to some embodiments, the second or risk assessment AI model may be utilized to analyze the request with respect to risk assessment rules and/or guidelines. In some embodiments for example, the method 500 may comprise determining (e.g., by the processing device) whether the risk level of the AI service request is acceptable (or “ok”), at 514. The second or risk assessment AI model may, for example, be prompted or otherwise trained to provide an assessment regarding whether the content of the request is low-risk, medium-risk, high-risk, and/or to compute a risk score for the request, user, user device, AI service, etc. In some embodiments, the risk assessment may result in one or more quantitative and/or qualitative result (e.g., risk assessment) metrics (e.g., a second result metric). According to some embodiments, the result metric(s) may be compared to predetermined thresholds to determine whether the current request is acceptable (e.g., one or more result metrics are below a predetermined threshold or within an acceptable value range) or not (e.g., one or more result metrics are above a predetermined threshold or outside of an acceptable value range).

According to some embodiments, such as in a case where it is determined that the risk level is high, action may be automatically taken to minimize the risk (and/or potential damage), and/or to prevent additional high-risk requests/events. In some embodiments, a network device/asset may be disabled by blocking access thereto, shutting off power to a network device (e.g., the user's device itself), and/or changing network and/or device settings. In some embodiments, the disabling/mitigation/remediation may comprise one or more of: (i) encrypting a file, (ii) encrypting a server, (iii) encrypting a database, (iv) encrypting a website, (v) blocking access to an IP address, (vi) changing a DNS setting, (vii) changing a port setting, and (viii) powering-down a network device. In the case that the high-risk request is believed to constitute a potential malicious attempt originating from a particular country, for example, a domain and/or network-type asset may be modified by instituting geo-blocking that specifically excludes network traffic from the identified country. In the case that the high-risk request originates from a device that comprises a network device, such as a server, laptop, smart phone, switch, router, and/or firewall, power to the device/asset may be automatically disrupted and/or terminated, e.g., to stop and/or prevent malicious action.

In some embodiments, such as in a case where it is determined that the risk level is not acceptable, the method 500 may comprise determining (e.g., by the processing device) whether the AI service request can be modified, at 516. The request may be parsed, segmented, and/or otherwise analyzed, for example, to determine whether changes to the request may be likely to reduce the risk rating/score, e.g., and thereby render the risk level of the request acceptable. In some embodiments, such as in a case where no modification path can be identified, the method 500 may proceed back to generating the user response, at 510. The user response may indicate, for example that the request has failed a risk assessment and/or that no modifications to the request that could change the rating were readily identifiable. The user response may provide, for example, a suggestion that the user abandon the request, edit the request, and/or provide a new request. According to some embodiments, modifications may be identified that may be likely to reduce the risk rating/score of the request. In a case that the request is found to have SSNs or credit card numbers, for example, that increase the risk score, it may be determined that modifying those portions is likely to lower the risk score to an acceptable level.

According to some embodiments, the method 500 may comprise modifying (e.g., by the processing device) the AI service request, at 518. Data elements corresponding to the offending (e.g., SSNs and/or credit card numbers) portions of the request may be masked, deleted, and/or edited (e.g., by replacement with fake, random, and/or test data), for example. In some embodiments, the risk assessment may be repeated (not shown) after the modification, e.g., to verify the expected change/lowering. In some embodiments, such as in the case that the risk assessment at 514 produces an acceptable result and/or in the case that the request is modified at 518, the method 500 may continue to and/or comprise fingerprinting (e.g., by the processing device) the AI service request, at 520. The fingerprinting (and/or watermarking) may comprise, for example, analyzing the request utilizing a third or watermarking AI model. According to some embodiments, the third or watermarking AI model may be utilized to analyze and/or modify the request with respect to fingerprinting and/or watermarking rules and/or guidelines. The third or watermarking AI model may, for example, be prompted or otherwise trained to automatically insert, imbed, and/or otherwise modify the AI service request to include one or more fingerprinting and/or watermarking artifacts, tokens, patterns, etc. According to some embodiments, the third or watermarking AI model may identify and tag/mark certain portions of the AI service request, such as certain data elements, strings, and/or instances. The third or watermarking AI model may, for example, identify sensitive, unique, and/or proprietary data elements (e.g., names, numbers, case numbers, project or code names, etc.) within the AI service request and mark and/or tag such data elements, e.g., with a private and/or public key or hash. According to some embodiments, the watermarking may imbed a unique code and/or identifier into the request, such as a line-of-business, employee identifier (e.g., of the user), etc., as a seed and/or key for the encoding operation.

In some embodiments, the method 500 may comprise transmitting (e.g., by the processing device, via the electronic communication network, and/or to a remote AI service device) the AI service request, at 522. Once the AI service request is cleared by the AI enclave to be forwarded and/or transmitted, for example, information indicative of the request may be transmitted and/or provided to the requested AI service (e.g., as requested by the user). In some embodiments, as described herein, the AI service request may alternatively be routed and/or rerouted to a different AI service provider or the AI service provider may be selected from a plurality of available AI service providers. In a case where the AI service request comprises a request for sample code that accomplishes a particular task, for example, the AI enclave may automatically identify an AI service that specializes in (and/or has a historic success rate with) coding requests, e.g., whether or not the selected AI service was originally identified by the user. According to some embodiments, the AI service may be selected to give priority to an internal service that is available for use (e.g., as opposed to an external service) and/or to prioritize lower-cost and/or more trusted (e.g., having contractual relationships with the company) AI services.

According to some embodiments, the method 500 may comprise receiving (e.g., by the processing device, via the electronic communication network, and/or from the remote AI service device) an AI service response, at 524. The AI service response may be received subsequent to and/or in response to the transmission/submission of the AI service request, for example. In some embodiments, the AI service response may comprise various data elements, such as text, audio, and/or image/video elements. According to some embodiments, the AI service response may be received with a tag and/or identifier (e.g., a packet header and/or response identifier) that matches the AI service request to the particular AI service. In such a manner, for example, should the AI enclave be utilized by a large number of users simultaneously (which would likely be the case in an enterprise environment), the AI enclave may readily match incoming AI service responses with their corresponding AI service requests.

In some embodiments, the method 500 may comprise watermarking (e.g., by the processing device) the AI service response, at 526. The watermarking may comprise, for example, analyzing the AI service response to identify embedded and/or discernible fingerprinting patterns and/or elements within the AI service response and/or analyzing the AI service response to compute a statistical determination regarding whether the AI service response is human-generated or AI-generated. According to some embodiments, the watermarking may comprise execution of a watermarking AI model that analyzes the AI service response utilizing one or more watermarking algorithms to identify markers, artifacts, patterns, and/or tokens. In some embodiments, the watermarking may comprise application of one or more public and/or private keys to decode data embedded within the AI service response. In such a manner, for example, data elements that originated within the AI enclave (e.g., enterprise and/or company) may be identified within the AI service response. In a case where the AI service is not supposed to allow enterprise data (e.g., from the AI service request) to be presented in AI service responses and the watermarking identifies such data, an alert may be issued to flag the problem. In some embodiments, the results of the watermarking may be fed back into the training and/or retraining of one or more AI enclave models, at 502.

According to some embodiments, the method 500 may comprise forwarding or outputting (e.g., by the processing device, via the electronic communication network, and/or to the remote user device and/or interface) the AI response, at 528. The AI enclave may pass the AI service response to the user that requested the AI service, for example, e.g., in response to the original receiving of the AI service request, at 504. In some embodiments, the AI service request may be entered by the user into an interface and the AI service responses may be output in response to the request via the same interface. In such a manner, for example, and in a case where the AI service request passes all assessments and is deemed appropriate or “safe” to transmit to the AI service for execution, the communication between the user and the AI service may appear seamless to the user. In other words, the presence and/or operation of the AI enclave may not be discernible to the user in application (e.g., unless a request is rejected for failing an assessment). According to some embodiments, the AI service response may also or alternatively be fed back into the training and/or retraining of the AI enclave model(s), at 502. In such a manner, for example, every session or instance of utilization of the AI enclave by a user may provide more data to the AI enclave model(s) to enhance the accuracy of the assessments and/or data management thereof.

In some embodiments, any transmissions that are sent and/or received between the various devices that may be utilized by the parties to the AI cybersecurity enclave system may be secured via any compression and/or encryption protocols that are or become known or practicable. According to some embodiments, fewer or more devices, data storage structures, chain code instances, and/or AI model executions may be included in the method 500.

Referring now to FIG. 6, a flow diagram of an example watermarking process or method 600 according to some embodiments is shown. In some embodiments, the method 600 may be performed and/or implemented by and/or otherwise associated with one or more specialized and/or specially-programmed computers (e.g., the user devices 102a-n, 202, 402 and/or the AI devices/apparatus 110, 210, 310, 410, 1010, all of FIG. 1, FIG. 2, FIG. 3, FIG. 4, and/or FIG. 10 herein), computer terminals, computer servers, computer systems and/or networks, and/or any combinations thereof (e.g., by one or more multi-threaded and/or multi-core processing units of an AI-driven cybersecurity enclave management system). In some embodiments, the method 600 may be embodied in, facilitated by, and/or otherwise associated with various input mechanisms and/or interfaces (e.g., the interfaces 220, 320, 720, 820, 920, 1020 of FIG. 2, FIG. 3, FIG. 7A, FIG. 7B, FIG. 7C, FIG. 7D, FIG. 8A, FIG. 8B, FIG. 9A, FIG. 9B, and/or FIG. 10 herein).

According to some embodiments, the method 600 may comprise identifying (e.g., by a processing device) an AI request, prompt, and/or input, as exemplified at 602. In some embodiments, the method 600 may comprise identifying (e.g., by the processing device) an AI response and/or output, as exemplified at 604. The AI response may comprise, for example, data output from a GenAI service in response to the request. According to some embodiments, the method 600 may comprise analyzing (e.g., by the processing device) a first version of the AI response, as exemplified at 606. The first version of the AI response may comprise, for purposes of example, a version of the response with no watermarking. As depicted, the first version of the response may comprise two (2) instances of a particular type of “token” 610, such as a character, word, and/or phrase. In the case of the unwatermarked first version of the response, the number or frequency of tokens 610 may be equivalent to what would statistically be expected to occur in human-generated text (i.e., two (2)).

In some embodiments, the method 600 may comprise analyzing (e.g., by the processing device) a second version of the AI response, as exemplified at 608. The second version of the AI response may comprise, for continuing purposes of example, a version of the response with watermarking. According to some embodiments, the second version of the response may, for example, have already been fingerprinted and/or watermarked (e.g., had watermarking artifacts inserted and/or embedded), e.g., as may have been seeded by a fingerprinted/watermarked AI services request (e.g., the request/prompt at 602). As depicted, the second version of the response may comprise ten (10) instances of a particular type of “token” 610, such as a character, word, and/or phrase. In the case of the watermarked second version of the response, the number or frequency of tokens 610 may be greater than what would statistically be expected to occur in human-generated text (i.e., two (2)).

According to some embodiments, the method 600 may comprise identifying whether the AI response (e.g., at 604) is AI-generated (or otherwise contains identifiable markings or patterns) or human-generated (or does not contain identifiable markings or patterns). The method 600 may, for example, comprise computing and/or calculating any of a variety of watermarking metrics 644a-e related to the tokens 610, such as, but not limited to: (i) “S” or spike entropy 644a, (ii) “(NW)z” or non-watermarked z-score 644b, (iii) “(W)z” or watermarked z-score 644c, (iv) “(NW)PPL” or non-watermarked perplexity 644d, and/or (v) “(W)PPL” or watermarked perplexity 644e. The method 600 may employ one or more watermarking insertion/creation techniques and/or one or more watermarking tests, utilizing the metrics 644a-e, for example, in accordance with the watermarking algorithms taught by Kirchenbauer et al. “A Watermark for Large Language Models”, University of Maryland, Jun. 6, 2023, such algorithms being hereby incorporated by reference herein.

### IV. AI-Driven Cybersecurity Enclave Interfaces

Turning now to FIG. 7A, FIG. 7B, FIG. 7C, and FIG. 7D, diagrams of an example interface system 720 according to some embodiments are shown. In some embodiments, the interface system 720 may be generated, defined, and/or output by and/or otherwise associated with one or more specialized and/or specially-programmed computers (e.g., the user devices 102a-n, 202, 402 and/or the AI devices/apparatus 110, 210, 310, 410, 1010, all of FIG. 1, FIG. 2, FIG. 3, FIG. 4, and/or FIG. 10 herein), computer terminals, computer servers, computer systems and/or networks, and/or any combinations thereof (e.g., by one or more multi-threaded and/or multi-core processing units of an AI-driven cybersecurity enclave management system). According to some embodiments, the interface system 720 may comprise one or more of a web page, web form, database entry form, API, spreadsheet, table, and/or application or other UI or GUI via which a user or other entity may enter data (e.g., provide or define input) descriptive of an AI service request/prompt and receive AI service response output, e.g., as managed by an AI enclave system and/or service, as described herein. The interface system 720 may, for example, comprise a front-end of an AI-driven cybersecurity enclave management system, program, model, and/or platform programmed and/or otherwise configured to execute, conduct, and/or facilitate the methods/algorithms 400, 500, 600, 1200 of FIG. 4, FIG. 5, FIG. 6, and/or FIG. 12 herein, and/or portions or combinations thereof.

According to some embodiments, the interface system 720 may comprise one or more tabs and/or other segmented and/or logically-presented data forms and/or fields. In some embodiments, the interface system 720 may be configured and/or organized to allow and/or facilitate identification, selection, and/or entry of information descriptive of one or more AI service requests, prompts, and/or input. According to some embodiments, the interface system 720 may comprise a menu and/or data entry page from which a user may select one or more options that initiate specific functionality of a mobile device and/or other computing application. The interface system 720 may comprise, for example, one or more data interface mechanisms 702a-b, one or more AI model prompts 704, one or more AI requests 706a-c (e.g., inputs), and/or one or more AI service responses 708a-b (e.g., outputs).

As depicted in FIG. 7A, for example, a first version (or page or instance) of the interface system 720 may comprise a terminal-style data entry interface that provides one or more data input and/or output mechanisms, tools, objects, and/or features, such as a first data interface mechanism 702a via which an AI model prompt 704 (e.g., “You are an AI assistant that helps people find information”) may be defined. According to some embodiments, the AI model prompt 704 may be invoked upon execution of an underlying AI model (e.g., an LLM and/or API), e.g., to respond to a first AI request 706a (e.g., “Hello, can you help me?”). As depicted, the AI model may generate a first AI service response 708a such as “Hello! How can I assist you today?”. As depicted in FIG. 7B, a first version (or page or instance) of the interface system 720 may comprise a second AI request 706b, such as the prompt “Can you write a short email to Coby Jack asking him to send money for his overdue insurance premium?”. This example prompt (the second AI request 706b) provides an exemplary use case where a user (not shown) may utilize the interface system 720 to invoke or request an AI service to generate content, such as an email. In some embodiments, other use cases may be implemented without deviating from the scope of this disclosure. According to some embodiments, the AI model may generate a second AI service response 708b in response to the second AI request 706b. As depicted in FIG. 7B, the second AI service response 708b may comprise a draft, AI-generated email in accordance with the second AI request 706b.

In some embodiments, and with reference to FIG. 7C, a third version (or page or instance) of the interface system 720 may provide a GUI-based or chat-style input and output interface that comprises a second data interface mechanism 702b that comprises the first AI request 706a, the first AI service response 708a, and/or the second AI request 706b. In some embodiments, the user-AI “conversation” may continue via a fourth version (or page or instance) of the interface system 720 as depicted in FIG. 7D, that may provide the GUI-based or chat-style input and output interface that comprises the second AI service response 708b and/or a third AI request 706c (or, as depicted, user input that does not necessarily constitute a request for an execution of the AI service).

According to some embodiments, the interface system 720 may be utilized, whether in terminal, GUI, and/or other style, to accept user inputs, such as AI service requests 706a-c, and provide AI service responses 708a-b in response thereto. In some embodiments, while the “conversations” depicted for example purposes with respect to the interface system 720 may appear to be direct communications between a user and an AI service, the front-end interface system 720 may mask a multitude of back-end processes and communications that occur between receipt and/or definition of any given AI service requests 706a-c and a receiving and/or defining of any AI service responses 708a-b in response thereto. In accordance with embodiments described herein, for example, an AI cybersecurity enclave may intercept and/or function between the user and the AI service, e.g., by executing one or more AI models that provide AI logging, AI fingerprinting/watermarking, AI content moderation, and/or AI risk assessment functions. In such a manner, for example, the user may utilize the interface system 720 without knowledge of the management that the AI enclave provides behind the scenes.

Fewer or more components 702a-b, 704, 706a-c, 708a-b and/or various configurations of the depicted components 702a-b, 704, 706a-c, 708a-b may be included in the interface system 720 without deviating from the scope of embodiments described herein. In some embodiments, the components 702a-b, 704, 706a-c, 708a-b may be similar in configuration and/or functionality to similarly named and/or numbered components as described herein. While various components of the interface system 720 have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Referring now to FIG. 8A and FIG. 8B, diagrams of an example interface system 820 according to some embodiments are shown. In some embodiments, the interface system 820 may be generated, defined, and/or output by and/or otherwise associated with one or more specialized and/or specially-programmed computers (e.g., the user devices 102a-n, 202, 402 and/or the AI devices/apparatus 110, 210, 310, 410, 1010, all of FIG. 1, FIG. 2, FIG. 3, FIG. 4, and/or FIG. 10 herein), computer terminals, computer servers, computer systems and/or networks, and/or any combinations thereof (e.g., by one or more multi-threaded and/or multi-core processing units of an AI-driven cybersecurity enclave management system). According to some embodiments, the interface system 820 may comprise one or more of a web page, web form, database entry form, API, spreadsheet, table, and/or application or other UI or GUI via which a user or other entity may enter data (e.g., provide or define input) descriptive of an AI service request/prompt and receive AI service response output, e.g., as managed by an AI enclave system and/or service, as described herein. The interface system 820 may, for example, comprise a front-end of an AI-driven cybersecurity enclave management system, program, model, and/or platform programmed and/or otherwise configured to execute, conduct, and/or facilitate the methods/algorithms 400, 500, 600, 1200 of FIG. 4, FIG. 5, FIG. 6, and/or FIG. 12 herein, and/or portions or combinations thereof.

According to some embodiments, the interface system 820 may comprise one or more tabs and/or other segmented and/or logically-presented data forms and/or fields. In some embodiments, the interface system 820 may be configured and/or organized to allow and/or facilitate identification, selection, and/or entry of information descriptive of one or more AI service requests, prompts, and/or input. According to some embodiments, the interface system 820 may comprise a menu and/or data entry page from which a user may select one or more options that initiate specific functionality of a mobile device and/or other computing application. With reference to FIG. 8A, the interface system 820 may comprise and/or define, for example, an AI prompt 804. As depicted, the AI prompt 804 may be complex, define various terms, data types, scenarios, etc. In some embodiments, developing and/or updating or editing the prompt 804 may comprise a training or retraining of an underlying AI model (e.g., an AI cybersecurity enclave model as described herein). According to some embodiments, and with reference to FIG. 8B, the interface system 820 may comprise and/or define one or more AI model responses 808a-d (and/or outputs). In the non-limiting example depicted in FIG. 8B, a first AI response 808a may comprise a first level, style, type, and/or instance of processing of the AI model with respect to a training or real-world scenario, e.g., sending a list of Social Security Numbers (SSNs) to a friend via email. According to some embodiments, the first AI response 808a may comprise a first execution or run-through of a first version or attempt of applying the AI prompt 804 to the scenario. In some embodiments, a second AI response 808b may comprise a second level, style, type, and/or instance of processing of the AI model with respect to the scenario. According to some embodiments, the second AI response 808b may comprise a second execution or run-through of a second version or attempt of applying the AI prompt 804 to the scenario.

In some embodiments, either or both of the first and second AI responses 808a-b (e.g., first and second “ideas” expressed by the AI model) may comprise a response that is utilized to evaluate a user request (e.g., a request for execution of an external AI service). According to some embodiments, as depicted in FIG. 8B for purposes of non-limiting example, the AI model processing may further generate a third AI response 808c that comprises a “critique” of the ideas (e.g., an analysis of the first and second AI responses 808a-b). As depicted, for example, the AI model may identify flaws (e.g., ambiguities) in the generated ideas and may utilize the identification and/or analysis of those flaws to generate the third AI response 808c as a critique or modified result of the AI model processing (e.g., a third level, style, type, and/or instance of processing of the AI model with respect to the scenario). In some embodiments, whether one or multiple levels, styles, types, and/or instances of processing of the AI model with respect to the scenario are utilized, the interface system 820 may output an indication of a “resolution” or fourth AI response 808d. In the depicted example of FIG. 8B, the fourth AI response 808d may comprise an indication of a risk score of four (4), e.g., on a scale of one (1) to five (5) as defined by the AI prompt 804. In such a manner, for example, the AI model may evaluate a user's AI service request, e.g., as a risk-based access control model.

Fewer or more components 804, 808a-d and/or various configurations of the depicted components 804, 808a-d may be included in the interface system 820 without deviating from the scope of embodiments described herein. In some embodiments, the components 804, 808a-d may be similar in configuration and/or functionality to similarly named and/or numbered components as described herein. While various components of the interface system 820 have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Turning now to FIG. 9A, FIG. 9B, and FIG. 9C, diagrams of an example interface system 920 according to some embodiments are shown. In some embodiments, the interface system 920 may be generated, defined, and/or output by and/or otherwise associated with one or more specialized and/or specially-programmed computers (e.g., the user devices 102a-n, 202, 402 and/or the AI devices/apparatus 110, 210, 310, 410, 1010, all of FIG. 1, FIG. 2, FIG. 3, FIG. 4, and/or FIG. 10 herein), computer terminals, computer servers, computer systems and/or networks, and/or any combinations thereof (e.g., by one or more multi-threaded and/or multi-core processing units of an AI-driven cybersecurity enclave management system). According to some embodiments, the interface system 920 may comprise one or more of a web page, web form, database entry form, API, spreadsheet, table, and/or application or other UI or GUI via which a user or other entity may enter data (e.g., provide or define input) descriptive of an AI service request/prompt and receive AI service response output, e.g., as managed by an AI enclave system and/or service, as described herein. The interface system 920 may, for example, comprise a front-end of an AI-driven cybersecurity enclave management system, program, model, and/or platform programmed and/or otherwise configured to execute, conduct, and/or facilitate the methods/algorithms 400, 500, 600, 1200 of FIG. 4, FIG. 5, FIG. 6, and/or FIG. 12 herein, and/or portions or combinations thereof.

According to some embodiments, the interface system 920 may comprise one or more tabs and/or other segmented and/or logically-presented data forms and/or fields. In some embodiments, the interface system 920 may be configured and/or organized to allow and/or facilitate identification, selection, and/or entry of information descriptive of one or more AI service requests, prompts, and/or input. According to some embodiments, the interface system 920 may comprise a menu and/or data entry page from which a user may select one or more options that initiate specific functionality of a mobile device and/or other computing application. The interface system 920 may comprise, for example, one or more data interface mechanisms 902a-b, one or more AI enclave model prompts 904a-b, one or more AI service requests 906a-b (e.g., inputs), and/or one or more AI enclave responses 908a-b (e.g., outputs).

As depicted in FIG. 9A, for example, a first version (or page or instance) of the interface system 920 may comprise and/or define a first AI enclave model prompt 904a that defines a set of AI enclave model instructions, guidelines, rules, thresholds, and/or prompts that are programmed to be applied/utilized in certain circumstances. In the case that a high risk score is computed by a risk assessment model or module of the AI enclave, such as in the case of a computed risk score of four (4) as resolved in the example of the interface system 820 of FIG. 8A and FIG. 8B herein for example, the first AI enclave model prompt 904a (e.g., a “paranoid prompt”) may be triggered and/or applied by the AI enclave model.

In some embodiments, as depicted in FIG. 9B, a second version (or page or instance) of the interface system 920 may comprise a terminal-style data entry interface that provides one or more data input and/or output mechanisms, tools, objects, and/or features, such as a first data interface mechanism 902a via which a second AI enclave model prompt 904b (e.g., “You are an AI assistant that helps people find information”) may be defined. According to some embodiments, the second AI enclave model prompt 904b may be invoked upon execution of an underlying AI model (e.g., an LLM and/or API), e.g., to respond to a first AI service request 906a (e.g., “Hello, can you help me?”), e.g., as depicted in FIG. 9C via a third version (or page or instance) of the interface system 920 that may comprise a GUI or chat-style data entry interface that provides one or more data input and/or output mechanisms, tools, objects, and/or features, such as a second data interface mechanism 902b. In some embodiments, the AI enclave model may invoke and/or utilize the second AI enclave model prompt 904b to respond to the first AI request 906a, such as by providing a first AI enclave response 908a (e.g., “How can I be of service to you today?”). According to some embodiments, a user (not shown) may enter, select, and/or otherwise define a second AI service request 906b (e.g., “Can you give me the premium cost for Bird Song Inc.'s insurance plan?”), as depicted in both the terminal-style first data interface mechanism 902a of FIG. 9B and the chat-style second data interface mechanism 902b of FIG. 9C.

In some embodiments, such as in the case that the AI enclave model performs an AI-driven risk assessment of the second AI service request 906b and the risk score/assessment is determined to be at a high level, the AI enclave model may invoke and/or utilize the first AI enclave model prompt 904a to generate and/or output a second AI enclave response 908b. As depicted, the second AI enclave response 908b may provide an indication that the second AI service request 906b has failed at least one assessment with respect to applicable (e.g., company) guidelines, e.g., by indicating that the requested information will not be provided and/or by changing the tone, style, and/or other characteristics of the text (and/or other media, not shown) of the second AI enclave response 908b (e.g., with respect to the first AI enclave response 908a). In such a manner, for example, the user's attempt to send a prompt (e.g., the second AI service request 906b) to an AI service (e.g., an external AI service) may be functionally denied (e.g., by the AI enclave refusing to forward the prompt to the requested service). In some embodiments, the AI enclave model may also or alternatively automatically direct (or redirect) the second AI service request 906b to a different (e.g., less risky) AI service than requested, such as an internal, trusted, and/or contractually-engaged AI service.

According to some embodiments, the interface system 920 may be utilized, whether in terminal, GUI, and/or other style, to accept user inputs, such as AI service requests 906a-b, and provide AI service responses 908a-b in response thereto. In some embodiments, while the “conversations” depicted for example purposes with respect to the interface system 920 may appear to be direct communications between a user and an AI service, the front-end interface system 920 may mask a multitude of back-end processes and communications that occur between receipt and/or definition of any given AI service requests 906a-b and a receiving and/or defining of any AI service responses 908a-b in response thereto. In accordance with embodiments described herein, for example, an AI cybersecurity enclave may intercept and/or function between the user and the desired AI service, e.g., by executing one or more AI models that provide AI logging, AI fingerprinting/watermarking, AI content moderation, and/or AI risk assessment functions. In such a manner, for example, the user may utilize the interface system 920 without knowledge of the management that the AI enclave provides behind the scenes.

Fewer or more components 902a-b, 904a-b, 906a-b, 908a-b and/or various configurations of the depicted components 902a-b, 904a-b, 906a-b, 908a-b may be included in the interface system 920 without deviating from the scope of embodiments described herein. In some embodiments, the components 902a-b, 904a-b, 906a-b, 908a-b may be similar in configuration and/or functionality to similarly named and/or numbered components as described herein. While various components of the interface system 920 have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

### V. AI-Driven Cybersecurity Enclave Apparatus, Articles of Manufacture, and Algorithms

Turning to FIG. 10, a block diagram of an apparatus 1010 according to some embodiments is shown. In some embodiments, the apparatus 1010 may be similar in configuration and/or functionality to any of the user devices 102a-n, 202, 402 and/or the AI devices/apparatus 110, 210, 310, 410, 1010, all of FIG. 1, FIG. 2, FIG. 3, FIG. 4, and/or FIG. 10 herein. The apparatus 1010 may, for example, execute, process, facilitate, and/or otherwise be associated with the methods/algorithms 400, 500, 600, 1200 of FIG. 4, FIG. 5, FIG. 6, and/or FIG. 12 herein, and/or portions or combinations thereof. In some embodiments, the apparatus 1010 may comprise a processing device 1012, a transceiver device 1014, an input device 1016, an output device 1018, an interface 1020, a memory device 1040 (storing various programs and/or instructions 1042 and data 1044), and/or a cooling device 1050. According to some embodiments, any or all of the components 1012, 1014, 1016, 1018, 1020, 1040, 1042, 1044, 1050 of the apparatus 1010 may be similar in configuration and/or functionality to any similarly named and/or numbered components described herein. Fewer or more components 1012, 1014, 1016, 1018, 1020, 1040, 1042, 1044, 1050 and/or various configurations of the components 1012, 1014, 1016, 1018, 1020, 1040, 1042, 1044, 1050 be included in the apparatus 1010 without deviating from the scope of embodiments described herein.

According to some embodiments, the processor 1012 may be or include any type, quantity, and/or configuration of processor that is or becomes known. The processor 1012 may comprise, for example, an Intel® IXP 2800 network processor or an Intel® XEON™ Processor coupled with an Intel® E8501 chipset. In some embodiments, the processor 1012 may comprise multiple inter-connected processors, microprocessors, and/or micro-engines. According to some embodiments, the processor 1012 (and/or the apparatus 1010 and/or other components thereof) may be supplied power via a power supply (not shown), such as a battery, an Alternating Current (AC) source, a Direct Current (DC) source, an AC/DC adapter, solar cells, and/or an inertial generator. In the case that the apparatus 1010 comprises a server, such as a blade server, necessary power may be supplied via a standard AC outlet, power strip, surge protector, and/or Uninterruptible Power Supply (UPS) device.

In some embodiments, the transceiver device 1014 may comprise any type or configuration of communication device that is or becomes known or practicable. The transceiver device 1014 may, for example, comprise a Network Interface Card (NIC), a telephonic device, a cellular network device, a router, a hub, a modem, and/or a communications port or cable. According to some embodiments, the transceiver device 1014 may also or alternatively be coupled to the processor 1012. In some embodiments, the transceiver device 1014 may comprise an IR, RF, Bluetooth™, Near-Field Communication (NFC), and/or Wi-Fi® network device coupled to facilitate communications between the processor 1012 and another device (not shown).

According to some embodiments, the input device 1016 and/or the output device 1018 are communicatively coupled to the processor 1012 (e.g., via wired and/or wireless connections and/or pathways) and they may generally comprise any types or configurations of input and output components and/or devices that are or become known, respectively. The input device 1016 may comprise, for example, a keyboard that allows an operator of the apparatus 1010 to interface with the apparatus 1010 (e.g., by a programmer to train/retrain an AI cybersecurity enclave AI model and/or by a user/employee attempting to access an AI service via an AI cybersecurity enclave, as described herein). The output device 1018 may, according to some embodiments, comprise a display screen and/or other practicable output component and/or device. The output device 1018 may, for example, provide an interface (such as the interface 1020 and/or the interfaces/interface systems 220, 320, 720, 820, 920 of FIG. 2, FIG. 3, FIG. 7A, FIG. 7B, FIG. 7C, FIG. 7D, FIG. 8A, FIG. 8B, FIG. 9A, FIG. 9B, and/or FIG. 9C herein) via which AI cybersecurity enclave data is communicated to a user (e.g., via a website and/or mobile application). According to some embodiments, the input device 1016 and/or the output device 1018 may comprise and/or be embodied in a single device, such as a touch-screen monitor.

The memory device 1040 may comprise any appropriate information storage device that is or becomes known or available, including, but not limited to, units and/or combinations of magnetic storage devices (e.g., a hard disk drive), optical storage devices, and/or semiconductor memory devices, such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1040 may, according to some embodiments, store one or more of AI logging instructions 1042-1, AI watermarking instructions 1042-2, AI content moderation instructions 1042-3, AI risk-based access control instructions 1042-4, AI routing instructions 1042-5, interface instructions 1042-6, user data 1044-1, device data 1044-2, security data 1044-3, log data 1044-4, watermark data 1044-5, AI service data 1044-6, and/or assessment data 1044-7. In some embodiments, the AI logging instructions 1042-1, AI watermarking instructions 1042-2, AI content moderation instructions 1042-3, AI risk-based access control instructions 1042-4, AI routing instructions 1042-5, interface instructions 1042-6, user data 1044-1, device data 1044-2, security data 1044-3, log data 1044-4, watermark data 1044-5, AI service data 1044-6, and/or assessment data 1044-7 may be utilized by the processor 1012 to provide output information via the output device 1018 and/or the transceiver device 1014.

According to some embodiments, the AI logging instructions 1042-1 may be operable to cause the processor 1012 to process the user data 1044-1, device data 1044-2, security data 1044-3, log data 1044-4, watermark data 1044-5, AI service data 1044-6, and/or assessment data 1044-7 in accordance with embodiments as described herein. User data 1044-1, device data 1044-2, security data 1044-3, log data 1044-4, watermark data 1044-5, AI service data 1044-6, and/or assessment data 1044-7 received via the input device 1016 and/or the transceiver device 1014 may, for example, be analyzed, sorted, filtered, decoded, decompressed, ranked, scored, plotted, and/or otherwise processed by the processor 1012 in accordance with the AI logging instructions 1042-1. In some embodiments, user data 1044-1, device data 1044-2, security data 1044-3, log data 1044-4, watermark data 1044-5, AI service data 1044-6, and/or assessment data 1044-7 may be fed by the processor 1012 through one or more mathematical and/or statistical formulas and/or models in accordance with the AI logging instructions 1042-1 to automatically identify, categorize, tag, store, and/or log data transmissions to implement an AI cybersecurity enclave management system, as described herein.

In some embodiments, the AI watermarking instructions 1042-2 may be operable to cause the processor 1012 to process the user data 1044-1, device data 1044-2, security data 1044-3, log data 1044-4, watermark data 1044-5, AI service data 1044-6, and/or assessment data 1044-7 in accordance with embodiments as described herein. User data 1044-1, device data 1044-2, security data 1044-3, log data 1044-4, watermark data 1044-5, AI service data 1044-6, and/or assessment data 1044-7 received via the input device 1016 and/or the transceiver device 1014 may, for example, be analyzed, sorted, filtered, decoded, decompressed, ranked, scored, plotted, and/or otherwise processed by the processor 1012 in accordance with the AI watermarking instructions 1042-2. In some embodiments, user data 1044-1, device data 1044-2, security data 1044-3, log data 1044-4, watermark data 1044-5, AI service data 1044-6, and/or assessment data 1044-7 may be fed by the processor 1012 through one or more mathematical and/or statistical formulas and/or models in accordance with the AI watermarking instructions 1042-2 to fingerprint, tag, embed, edit, watermark, and/or identify fingerprints and/or watermarks to implement an AI cybersecurity enclave management system, as described herein.

According to some embodiments, the AI content moderation instructions 1042-3 may be operable to cause the processor 1012 to process the user data 1044-1, device data 1044-2, security data 1044-3, log data 1044-4, watermark data 1044-5, AI service data 1044-6, and/or assessment data 1044-7 in accordance with embodiments as described herein. User data 1044-1, device data 1044-2, security data 1044-3, log data 1044-4, watermark data 1044-5, AI service data 1044-6, and/or assessment data 1044-7 received via the input device 1016 and/or the transceiver device 1014 may, for example, be analyzed, sorted, filtered, decoded, decompressed, ranked, scored, plotted, and/or otherwise processed by the processor 1012 in accordance with the AI content moderation instructions 1042-3. In some embodiments, user data 1044-1, device data 1044-2, security data 1044-3, log data 1044-4, watermark data 1044-5, AI service data 1044-6, and/or assessment data 1044-7 may be fed by the processor 1012 through one or more mathematical and/or statistical formulas and/or models in accordance with the AI content moderation instructions 1042-3 to automatically identify, categorize, tag, score, and/or analyze or assess content in accordance with stored prompts, rules, thresholds, and/or guidelines to implement an AI cybersecurity enclave management system, as described herein.

In some embodiments, the AI risk-based access control instructions 1042-4 may be operable to cause the processor 1012 to process the user data 1044-1, device data 1044-2, security data 1044-3, log data 1044-4, watermark data 1044-5, AI service data 1044-6, and/or assessment data 1044-7 in accordance with embodiments as described herein. User data 1044-1, device data 1044-2, security data 1044-3, log data 1044-4, watermark data 1044-5, AI service data 1044-6, and/or assessment data 1044-7 received via the input device 1016 and/or the transceiver device 1014 may, for example, be analyzed, sorted, filtered, decoded, decompressed, ranked, scored, plotted, and/or otherwise processed by the processor 1012 in accordance with the AI risk-based access control instructions 1042-4. In some embodiments, user data 1044-1, device data 1044-2, security data 1044-3, log data 1044-4, watermark data 1044-5, AI service data 1044-6, and/or assessment data 1044-7 may be fed by the processor 1012 through one or more mathematical and/or statistical formulas and/or models in accordance with the AI risk-based access control instructions 1042-4 to dynamically assess risk metrics for a user, user device, AI service request, and/or AI service, e.g., by computing a risk score, to implement an AI cybersecurity enclave management system, as described herein.

According to some embodiments, the AI routing instructions 1042-5 may be operable to cause the processor 1012 to process the user data 1044-1, device data 1044-2, security data 1044-3, log data 1044-4, watermark data 1044-5, AI service data 1044-6, and/or assessment data 1044-7 in accordance with embodiments as described herein. User data 1044-1, device data 1044-2, security data 1044-3, log data 1044-4, watermark data 1044-5, AI service data 1044-6, and/or assessment data 1044-7 received via the input device 1016 and/or the transceiver device 1014 may, for example, be analyzed, sorted, filtered, decoded, decompressed, ranked, scored, plotted, and/or otherwise processed by the processor 1012 in accordance with the AI routing instructions 1042-5. In some embodiments, user data 1044-1, device data 1044-2, security data 1044-3, log data 1044-4, watermark data 1044-5, AI service data 1044-6, and/or assessment data 1044-7 may be fed by the processor 1012 through one or more mathematical and/or statistical formulas and/or models in accordance with the AI routing instructions 1042-5 to automatically route, direct, redirect, and/or otherwise transmit and/or receive AI service request and/or response data, e.g., based on request type, bandwidth, processing, and/or cost constraints and/or metrics, to implement an AI cybersecurity enclave management system, as described herein.

In some embodiments, the interface instructions 1042-6 may be operable to cause the processor 1012 to process the user data 1044-1, device data 1044-2, security data 1044-3, log data 1044-4, watermark data 1044-5, AI service data 1044-6, and/or assessment data 1044-7 in accordance with embodiments as described herein. User data 1044-1, device data 1044-2, security data 1044-3, log data 1044-4, watermark data 1044-5, AI service data 1044-6, and/or assessment data 1044-7 received via the input device 1016 and/or the transceiver device 1014 may, for example, be analyzed, sorted, filtered, decoded, decompressed, ranked, scored, plotted, and/or otherwise processed by the processor 1012 in accordance with the interface instructions 1042-6. In some embodiments, user data 1044-1, device data 1044-2, security data 1044-3, log data 1044-4, watermark data 1044-5, AI service data 1044-6, and/or assessment data 1044-7 may be fed by the processor 1012 through one or more mathematical and/or statistical formulas and/or models in accordance with the interface instructions 1042-6 to generate, define, and/or output one or more terminal-style, chat-style, and/or GUI interfaces to implement an AI cybersecurity enclave management system, as described herein

According to some embodiments, the apparatus 1010 may comprise the cooling device 1050. According to some embodiments, the cooling device 1050 may be coupled (physically, thermally, and/or electrically) to the processor 1012 and/or to the memory device 1040. The cooling device 1050 may, for example, comprise a fan, heat sink, heat pipe, radiator, cold plate, and/or other cooling component or device or combinations thereof, configured to remove heat from portions or components of the apparatus 1010.

Any or all of the exemplary instructions and data types described herein and other practicable types of data may be stored in any number, type, and/or configuration of memory devices that is or becomes known. The memory device 1040 may, for example, comprise one or more data tables or files, databases, table spaces, registers, and/or other storage structures. In some embodiments, multiple databases and/or storage structures (and/or multiple memory devices 1040) may be utilized to store information associated with the apparatus 1010. According to some embodiments, the memory device 1040 may be incorporated into and/or otherwise coupled to the apparatus 1010 (e.g., as shown) or may simply be accessible to the apparatus 1010 (e.g., externally located and/or situated).

Referring to FIG. 11A, FIG. 11B, FIG. 11C, FIG. 11D, and FIG. 11E, perspective diagrams of exemplary data storage devices 940a-e according to some embodiments are shown. The data storage devices 1140a-e may, for example, be utilized to store instructions and/or data, such as the AI logging instructions 1042-1, AI watermarking instructions 1042-2, AI content moderation instructions 1042-3, AI risk-based access control instructions 1042-4, AI routing instructions 1042-5, interface instructions 1042-6, user data 1044-1, device data 1044-2, security data 1044-3, log data 1044-4, watermark data 1044-5, AI service data 1044-6, and/or assessment data 1044-7, each of which is presented in reference to FIG. 10 herein. In some embodiments, instructions stored on the data storage devices 1140a-e may, when executed by a processor, cause the implementation of and/or facilitate the methods/algorithms 400, 500, 600, 1200 of FIG. 4, FIG. 5, FIG. 6, and/or FIG. 12 herein, and/or portions or combinations thereof.

According to some embodiments, the first data storage device 1140a may comprise one or more various types of internal and/or external hard drives. The first data storage device 1140a may, for example, comprise a data storage medium 1146 that is read, interrogated, and/or otherwise communicatively coupled to and/or via a disk reading device 1148. In some embodiments, the first data storage device 1140a and/or the data storage medium 1146 may be configured to store information utilizing one or more magnetic, inductive, and/or optical means (e.g., magnetic, inductive, and/or optical-encoding). The data storage medium 1146, depicted as a first data storage medium 1146a for example (e.g., breakout cross-section “A”), may comprise one or more of a polymer layer 1146a-1, a magnetic data storage layer 1146a-2, a non-magnetic layer 1146a-3, a magnetic base layer 1146a-4, a contact layer 1146a-5, and/or a substrate layer 1146a-6. According to some embodiments, a magnetic read head 1148a may be coupled and/or disposed to read data from the magnetic data storage layer 1146a-2.

In some embodiments, the data storage medium 1146, depicted as a second data storage medium 1146b for example (e.g., breakout cross-section “B”), may comprise a plurality of data points 1146b-2 disposed with the second data storage medium 1146b. The data points 1146b-2 may, in some embodiments, be read and/or otherwise interfaced with via a laser-enabled read head 1148b disposed and/or coupled to direct a laser beam through the second data storage medium 1146b.

In some embodiments, the second data storage device 1140b may comprise a CD, CD-ROM, DVD, Blu-Ray™ Disc, and/or other type of optically-encoded disk and/or other storage medium that is or becomes know or practicable. In some embodiments, the third data storage device 1140c may comprise a USB keyfob, dongle, and/or other type of flash memory data storage device that is or becomes know or practicable. In some embodiments, the fourth data storage device 1140d may comprise RAM of any type, quantity, and/or configuration that is or becomes practicable and/or desirable. In some embodiments, the fourth data storage device 1140d may comprise an off-chip cache, such as a Level 2 (L2) cache memory device. According to some embodiments, the fifth data storage device 1140e may comprise an on-chip memory device, such as a Level 1 (L1) cache memory device.

The data storage devices 1140a-e may generally store program instructions, code, and/or modules that, when executed by a processing device cause a particular machine to function in accordance with one or more embodiments described herein. The data storage devices 1140a-e depicted in FIG. 11A, FIG. 11B, FIG. 11C, FIG. 11D, and FIG. 11E are representative of a class and/or subset of computer-readable media that are defined herein as “computer-readable memory” (e.g., non-transitory memory devices as opposed to transmission devices or media).

With reference to FIG. 12, for example, the data storage devices 1140a-e may store and/or define an algorithm 1200. The algorithm 1200 may comprise, for example, one or more software programs, modules, engines, models (e.g., AI models), and/or applications coded to perform any of the methods 400, 500, 600 of FIG. 4, FIG. 5, and/or FIG. 6 herein, and/or portions or combinations thereof. The algorithm 1200, and any reference to the term “algorithm” herein, refers to any set of defined instructions and/or trained instruction, guidelines, and/or prompt sets that operate upon input to define and/or provide output. The algorithm 1200 may, for example, be specifically programmed, trained, and/or otherwise defined to instruct a computer or other device (not shown) to solve a particular problem (e.g., logical) and/or resolve a particular mathematical calculation (e.g., arithmetic). In some embodiments, the algorithm 1200 may be written and/or defined as a series or sequence of instructions, guidelines, formulas, thresholds, rules, and/or prompts encoded in (e.g., written in accordance with syntax and/or semantics rules) a particular computer programming language (e.g., Python™, Java™, JavaScript™, C, C++, C #, Basic™, FORTRAN, COBOL, Ruby™, and/or Perl™), e.g., a set of instructions that convert and/or encode characters, objects, and/or other data elements into machine code (e.g., code operable to be executed by an electronic processing device, such as a CPU).

According to some embodiments, the algorithm 1200 may comprise soliciting input, at 1202. Input from one or more sources may be searched for and/or queried, by structuring and/or executing a database query and/or by sending a data communication signal or “handshake”, such as is common with Bluetooth® short-range communication protocols. In some embodiments, the algorithm 1200 may comprise receiving the input, at 1204. Whether solicited or otherwise provided and/or acquired (e.g., loaded and/or downloaded), for example, the input for the algorithm 1200 may be received, identified, and/or otherwise processed and/or located. According to some embodiments, the algorithm 1200 may comprise data processing, at 1212. The data processing 1212 may, for example, comprise execution of one or more logical and/or computational procedures, modules, scripts, models, and/or routines that may be stored in a memory device 1240 (e.g., similar to the data storage devices 1140a-e) as a set of instructions or rules 1242 and/or that may be defined and/or implemented by one or more electrical, mechanical, and/or physical components, such as logic gates, diodes, transistors, relays, and/or switches (e.g., operable to execute any of the methods 400, 500, 600 of FIG. 4, FIG. 5, and/or FIG. 6 herein, and/or portions or combinations thereof).

In some embodiments, execution of the algorithm 1200 may comprise a loading of the rules 1242 into the memory 1240 and/or into an electronic processing system (not shown) and/or an activation of one or more logic gates and/or other electrical and/or mechanical components. The algorithm 1200 may operate upon the input in accordance with the rules 1242 to achieve a result by defining output, at 1218. The algorithm 1200 may, for example, generate, produce, define, identify, calculate, and/or otherwise compute output based on an application of the data processing 1212 utilizing the rules 1242 and any or all input receiving at 1204. According to some embodiments, the algorithm 1200 may comprise providing the output, at 1220. One or more output devices (not shown) may be utilized to convey the output (e.g., a result, conclusion, decision, etc.) to one or more other devices and/or entities (not shown), such as one or more users, consumers, customers, potential customers, and/or devices utilized thereby. The output may be displayed via an electronic display screen of a computer, mobile/smart phone, smart watch, etc., and/or may be transmitted as one or more electronic signals to one or more network destination addresses, such as email addresses, URL locations, MAC addresses, and/or broadcast radio frequencies.

According to some embodiments, the data processing at 1212 may comprise execution of a listing, sequence, matrix, and/or other set of stored steps and/or instructions that utilize the input to define the output. In some embodiments, the listing of steps and/or instruction details may comprise elements that are known to those skilled in the art. The algorithm 1200 may partially or completely comprise, for example, instructions and/or steps that are well known, such as steps and/or instructions operable to calculate an area (length times width), volume (length times width times height), distance (difference between two locations), velocity (distance over time), acceleration (velocity over time), and/or any other known mathematical and/or logical (if/then statements) procedures. For any and all known procedures and/or instructions, the discrete details of such instructions are represented by the data processing at 1212 and are not listed herein as one of ordinary skill in the art would readily comprehend both what such technological knowledge entails and that the inventor has possession of such knowledge. Instructions that may be included within and/or comprise the data processing at 1212 (and/or the algorithm 1200) may include, for example, but are not limited to, any known or practicable: (i) communication protocols and/or algorithms, (ii) AI and/or ML data input classification algorithms, (iii) data transmission algorithms, (iv) data encoding algorithms, (v) data decoding algorithms, (vi) logical and/or mathematical data comparison algorithms, and (vii) data searching (e.g., keyword searching) algorithms.

### VI. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The indefinite articles “a” and “an,” as used herein in the specification and in the claims, unless clearly indicated to the contrary, should be understood to mean “at least one.” This rule applies even within the body of a claim where a first instance of an element utilizes “a” or “an” and a second or subsequent instance of the element necessarily utilizes (e.g., for purposes of proper grammar and required antecedent basis) the definite article “the” to refer to the element. The use of the definite article “the” does not limit the element to a single object merely because it is utilized to refer back to a previous mention of the element. The original reference to the element controls with respect to the plurality (or lack thereof) of the element.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

What is claimed is:

1. An Artificial Intelligence (AI)-driven method for implementing a cybersecurity enclave, comprising:
training, by at least one electronic processing device and utilizing a first set of AI training prompts, an AI enclave management model stored in at least one non-transitory computer readable medium in communication with the at least one electronic processing device;
receiving, by the at least one electronic processing device and from a user device, a request for an AI service;
identifying, by the AI enclave management model, whether content of the request complies with content management rules stored in the at least one non-transitory computer readable medium;
computing, by the AI enclave management model, and utilizing risk assessment rules stored in the at least one non-transitory computer readable medium, a risk score for the request;
determining, by the AI enclave management model, based on the identifying of whether the content of the request complies with the content management rules and based on the risk score for the request, that the request is cleared to be sent to the AI service;
transmitting, by the at least one electronic processing device, the request to the AI service;
receiving, by the at least one electronic processing device and in response to the transmitting, and from the AI service, a response; and
transmitting, by the at least one electronic processing device and to the user device, information indicative of the response; and
editing, by the at least one electronic processing device and prior to the transmitting of the request to the AI service, the request, wherein the editing comprises adding a watermark to the content of the request.

2. The AI-driven method of claim 1, further comprising:
identifying, by the at least one electronic processing device and via an analysis of the response, the watermark in content of the response.

3. The AI-driven method of claim 1, further comprising:
generating, by the at least one electronic processing device and based on the response, a second set of AI training prompts; and
retraining, utilizing the second set of AI training prompts, the AI enclave management model.

4. The AI-driven method of claim 1, wherein the information indicative of the response comprises the response.

5. The AI-driven method of claim 1, wherein the at least one electronic processing device comprises multiple processing devices.

6. The AI-driven method of claim 1, wherein the first set of prompts are defined utilizing a plurality of data thresholds.

7. The AI-driven method of claim 1, wherein the first set of prompts are defined based on historical data.

8. The AI-driven method of claim 1, wherein the AI service comprises a remote AI service.

9. The AI-driven method of claim 1, wherein the identifying that the content of the request complies with the content management rules comprises a first execution of the AI enclave management model.

10. The AI-driven method of claim 9, wherein the computing of the risk score for the request comprises a second execution of the AI enclave management model.

11. The AI-driven method of claim 1, wherein the identifying that the content of the request complies with the content management rules comprises execution of a first Large Language Model (LLM).

12. The AI-driven method of claim 11, wherein the computing of the risk score for the request comprises:
identifying a user identifier for a user of the user device;
identifying a machine identifier for the user device;
categorizing, by the first LLM, the content of the request into one of a plurality of categories; and
computing, based on (i) data stored in association with the user identifier, (ii) data stored in association with the machine identifier, and (iii) data stored in association with the one of the plurality of categories, the risk score.

13. The AI-driven method of claim 12, wherein the risk score comprises a qualitative metric.

14. The AI-driven method of claim 11, wherein the identifying that the content of the request complies with the content management rules further comprises execution of a second LLM.

15. The AI-driven method of claim 11, further comprising:
categorizing, by the first LLM, the content of the request; and
selecting, based on the categorizing, the AI service from a plurality of available AI services.

16. The AI-driven method of claim 11, further comprising:
categorizing, by the first LLM, the content of the request into one of a plurality of categories;
computing a cost for the request;
identifying a budget for the one of the plurality of categories; and
identifying, by a comparison of the budget to the cost for the request, that the request is within the budget.

17. The AI-driven method of claim 1, further comprising:
logging, by the at least one electronic processing device, data descriptive of the request and the response.

18. The AI-driven method of claim 1, further comprising:
automatically identifying, between the transmitting of the request to the AI service and the receiving of the response from the AI service, a delay in the receiving of the response; and
automatically retransmitting, after the identifying of the delay in the receiving of the response, the request to the AI service,
wherein the response from the AI service is received in response to the retransmitting of the request.

19. The AI-driven method of claim 1, wherein the identifying that the content of the request complies with the content management rules comprises:
identifying that the content of the request fails to comply with the content management rules;
identifying a change to the request that would permit the request to comply with the content management rules; and
editing the request to include the identified change.

20. The AI-driven method of claim 19, wherein the identifying that the content of the request fails to comply with the content management rules comprises identifying a prohibited type of information in the content of the request and wherein the change comprises a masking of a portion of the content of the request that corresponds to the prohibited type of information.

21. The AI-driven method of claim 20, wherein the masking comprises altering a data value in the portion of the content of the request that corresponds to the prohibited type of information.

22. The AI-driven method of claim 21, wherein the data value comprises at least one number of at least one of a social security number, a credit card number, an account number, a user identifier, an address, and a phone number.
